(19) United States
(12) Patent Application Publication
(10) Pub. No.: US 2021/0348585 A1
(43) Pub. Date: Nov. 11, 2021

(54) NOZZLE WITH MICROSTRUCTURED THROUGH-HOLES

(71) Applicant: 3M INNOVATIVE PROPERTIES COMPANY, St. Paul, MN (US)

(72) Inventors: Scott M. Schnobrich, Stillwater, MN (US); Barry S. Carpenter, Oakdale, MN (US)

(21) Appl. No.: 17/273,754

(22) PCT Filed: Sep. 13, 2019
(86) PCT No.: PCT/US2019/050990

§ 371 Date: Mar. 5, 2021

Related U.S. Application Data
(60) Provisional application No. 62/730,749, filed on Sep. 13, 2018.

(51) Int. Cl. F02M 61/18

(52) U.S. Cl. CPC F02M 61/1833; F02M 61/184

(57) ABSTRACT

A nozzle (10) comprising a through-hole (20) having an optional initial section (36) in fluid communication with the inlet opening (21) of the through-hole (20), a fluid shearing section (40) in fluid communication with the outlet opening (32) of the through-hole (20), and an optional transition region (38) in fluid communication with the initial section (36) and the fluid shearing section (40). The initial section (36) has a relatively constant cross-sectional shape along at least a 20% portion of its length, a shape that converges to the transition region (38), or both. The transition region (38) is disposed along the through-hole length, with a relatively uniform, diverging, converging, diverging and converging, or converging and diverging cross-sectional area along its length. The fluid shearing section (40) has an upstream end in fluid communication with the transition region (38), and a diverging cross-sectional shape along at least a 20% portion of its length that has a minor axis length and a major axis length.

The present invention relates to nozzles (e.g., fuel injector nozzles), in particular to nozzles that include a nozzle structure or component (e.g., a nozzle plate, a monolithic nozzle plate and valve guide, or an assembled nozzle plate and valve guide) having one or more microstructured through-holes or ports, more particularly to a nozzle structure or component having one or more through-holes or ports that include an optional transition region disposed in fluid communication between an optional initial section and a fluid shearing section, methods of making the same, and methods of using the same.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Fuel injection has become the preferred method of fuel delivery in combustion engines, thus minimizing the demand or need for carburetor-based systems. In a fuel injected system, it is necessary that the fuel injector nozzles deliver the precise amount of fuel for the appropriate air/fuel mixture in the combustion process for optimal engine performance and engine lifetime. Some fuel injector nozzles fail to provide a fuel spray that breaks up into a desired droplet pattern or plume at an optimum distance from the nozzle. In addition, the droplets may not break up into a known distribution during every injection event. A poorly designed fuel spray pattern or plume and variations in breakup distance can lead to incomplete combustion, which in turn leads to higher emissions, lower fuel economy, and the build-up of combustion byproducts (e.g., coking) within the combustion chamber of the engine.

There are a number of different fuel injectors with nozzles that can produce a variety of fuel spray plumes or patterns. There is an ongoing need, however, to develop improvements to previous nozzle designs in an effort to improve the fuel combustion process. The present invention is directed to such an improved nozzle design.

### SUMMARY OF THE INVENTION

The present invention provides a new fluid supply nozzle that includes, in one or more embodiments, a nozzle structure (e.g., in the form of a monolithic nozzle plate, a monolithic nozzle plate and valve guide, or an assembled nozzle plate and valve guide) having an inlet surface on an inlet side, an outlet surface on an outlet side, a thickness between the inlet surface and the outlet surface, and at least one through-hole having an inlet opening on the inlet surface, an outlet opening on the outlet surface, and a cavity that provides fluid communication between the inlet opening and the outlet opening.

In one aspect of the present invention the cavity comprises, consists essentially of, or consists of a fluid shearing section in fluid communication at a downstream end with the outlet opening of the through-hole and in fluid communication at an upstream end with the inlet opening of the through-hole, and an optional transition region disposed so as to be in fluid communication with an upstream end of the fluid shearing section. The fluid shearing section of the cavity has (a) a length between an upstream end and a downstream end, with the upstream end being directly or indirectly connected or otherwise in fluid communication with a downstream end of the transition region, (b) a diverging cross sectional shape along at least a portion of its length, the diverging cross-sectional shape having a minor axis with a length and a major axis with a length, and the major axis length increases toward the downstream end of the fluid shearing section, and optionally the minor axis length decreases toward the downstream end of the fluid shearing section. When used, the transition region can be disposed at a single point along the length of the through-hole with one cross-sectional area. Alternatively, the transition region can span a sub-length of the overall through-hole length, with a cross-sectional area along the length of the transition region being either relatively uniform, diverging, converging, diverging and converging, or converging and diverging from its upstream end to its downstream end.

In another aspect of the present invention the cavity comprises, consists essentially of, or consists of an initial section in fluid communication at an upstream end with the inlet opening of the through-hole, a fluid shearing section in fluid communication at a downstream end with the outlet opening of the through-hole, and a transition region disposed therebetween so as to be in fluid communication with a downstream end of the initial section and an upstream end of the fluid shearing section, The initial section of the cavity has a length and either (a) a relatively uniform or otherwise constant cross sectional shape along at least a 20% portion of its length, (b) a converging shape that converges from the inlet opening of the through-hole to the transition region, or (c) both (a) and (b). The transition region is disposed at a single point along the length of the through-hole with one cross-sectional area, or the transition region overlaps the through-hole length, with a cross-sectional area along the length of the transition region being either relatively uniform, diverging, converging, diverging and converging, or converging and diverging from its upstream end to its downstream end. The fluid shearing section of the cavity has a length between an upstream end and a downstream end, with the upstream end being in fluid communication with a downstream end of the transition region, a diverging cross sectional shape along at least a 20% portion of its length, the diverging cross-sectional shape having a minor axis with a length and a major axis with a length, and the major axis length increases (i.e., the fluid shearing section diverges in the major axis direction along its length) toward the downstream end of the fluid shearing section, and optionally the minor axis length decreases (i.e., the fluid shearing section converges in the minor axis direction along its length) toward the downstream end of the fluid shearing section.

In one or more embodiments of the present nozzle structure, (i) the ratio of the major axis length to the minor axis length of the diverging cross-sectional shape of the fluid shearing section is at least 2:1 or greater, (ii) the cross-sectional area at the downstream end of the fluid shearing section is equal to or less than the cross-sectional area at the upstream end of the fluid shearing section, (iii) the cross-sectional area of the downstream end of the fluid shearing section is equal to or less than the cross-sectional area at the upstream end of the initial section, (iv) the major axis length increases toward the downstream end of the fluid shearing section and the minor axis length decreases toward the downstream end of the fluid shearing section, or (v) any combination of (i), (ii), (iii) and (iv).

In one or more other embodiments, fluid (e.g., a liquid fuel) exiting the through-hole or port can consistently break up into droplets at a desired distance from the outlet openings of the nozzle through-hole(s) and the droplets breakup into a desired average droplet size, droplet distribution, and droplet pattern or plume. The spray patterns and breakup distances provided by one or more embodiments of the present invention can, when used in fuel injection systems for combustion engines, improve the combustion characteristics of the delivered fuel, which in turn can lead to one or any combination of lower emissions, improved fuel economy, and reduced build-up of byproducts within an internal combustion (“IC”) engine.

It can be advantageous to have a repeatable spray pattern or plume, in addition to maintaining a particular optimum droplet size and distribution, from one injection event to the next. In an internal combustion engine, e.g., it can be desirable to have smaller droplets, because reducing the droplet size can increase the overall droplet surface area, which reduces the fuel available for quenching the fuel's burning and can allow the droplets to evaporate faster and burn more completely, inside the combustion chamber of the internal combustion engine. A more complete burn can allow the engine to run at a lower equivalence ratio, or leaner, which means less fuel can be needed for each fuel injection and combustion event or cycle, thereby improving the fuel efficiency of the IC engine.

The size of the fuel droplets can also affect the depth of penetration of the fuel from the nozzle into the combustion chamber, or the penetration distance of the fuel from the nozzle outlet face or surface, for a given combustion cycle or event. The fuel droplet size can be affected by the geometry of the through-hole cavity, independent of the pressure of the supplied fuel. The penetration distance can be affected by the flow rate of the fuel as it exits the nozzle through-hole. The flow rate of the exiting fuel can be affected by the geometry of the through-hole cavity, independent of the pressure of the supplied fuel. Adjusting the through-hole cavity geometry to adjust the penetration distance of each fuel stream, the size of the fuel droplets in each fuel stream, or both, can be used to change the shape of (e.g., spread-out) the overall fuel pattern formed by the individual through-hole fuel stream(s) exiting the fuel injector nozzle. This technique can allow for more efficient mixing of the fuel with the fresh air charge (i.e., the amount of fresh air being supplied into the combustion chamber for each combustion event).

Although not wishing to be bound by theory, the exemplary nozzle structures incorporating one or more of the through-holes, as described herein, may provide particular advantages in both droplet size distribution and spray pattern not provided in a cost-effective manner by existing injection systems. For example, it is theorized that the angular momentum provided to a fluid (i.e., a liquid or gas fuels) by each individual through-hole or port, or the combination of through-holes in the nozzle structures, as described herein, can allow the selection of a desired spray pattern exiting from the fuel injector nozzle through-holes or ports. In addition, the transverse shear forces exhibited by the fluid in the fluid shearing section can cause droplets to form having an advantageous size distribution after the fluid exits the fuel injector nozzle through-holes or ports and also control the droplet pattern and depth of penetration.

The addition of a counterbore to the through-holes or ports of a nozzle structure as described herein may, in one or more embodiments, provide additional control over the length of the through-holes or ports within a nozzle structure as described herein and may, therefore, provide further control over the fluid (e.g., fuel) droplet size distribution and spray pattern.

Therefore, in other aspects of the present invention, a fuel injector is provided that comprises a nozzle according to present invention, a fuel system is provided that comprises such a fuel injector, and an internal combustion engine is provided that comprises such a fuel system. It can be desirable for the internal combustion engine to be a gasoline direct injection engine.

These and other aspects, features and/or advantages of the invention may be shown and described in the drawings and detailed description herein, where like reference numerals are used to represent similar parts. It is to be understood, however, that the drawings and description are for illustration purposes only and should not be read in a manner that would unduly limit the scope of this invention.

The above summary of the present invention is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE DRAWING

In the accompanying drawing:

FIG. 1. is an enlarged cross-sectional partial side view of a fuel injector nozzle according to one embodiment of the present invention;

FIG. 2 is a partially sectioned side view of a fuel injector nozzle according to another embodiment of the present invention;

FIG. 3A is a partially sectioned side view of a valve stem guide and nozzle plate according to one embodiment of the present invention;

FIG. 3B is a top view of the valve stem guide and nozzle plate of FIG. 3A;

FIG. 4A is a cross-sectional side view of a nozzle plate according to one embodiment of the present invention;

FIG. 4B is an enlarged view of the circled area of FIG. 4A;

FIG. 5A is a top view of the nozzle plate of FIG. 4A;

FIG. 5B is an enlarged view of the circled area of FIG. 5A;

FIG. 5C is a bottom view of the nozzle plate of FIG. 4A;

FIG. 5D is an enlarged view of the circled area of FIG. 5C;

FIGS. 6A and 6B are a top view and perspective view, respectively, of an array of nozzle through-hole forming microstructures according to one embodiment of the present invention;

FIGS. 7A-14A are each a side view and FIGS. 7B-14B are each a top view of various exemplary nozzle through-hole forming microstructure according to the present invention;

FIG. 15 is a side view of an exemplary nozzle through-hole forming microstructure according to the present invention;

FIGS. 16A and 16B are a side view and front view, respectively, of an exemplary nozzle through-hole forming microstructure according to the present invention;

FIG. 17 is a side view of an exemplary nozzle through-hole forming microstructure according to the present invention;

FIGS. 18A and 18B are a front view and side view, respectively, of an exemplary nozzle through-hole forming microstructure according to the present invention;

FIGS. 19A and 19B are a side view and top view, respectively, of an exemplary nozzle through-hole forming microstructure according to the present invention;

FIG. 20 is a schematic side view of an exemplary fluid plume from a nozzle according to the present invention;

FIG. 21 is a graph showing the change in cross-sectional open area along the height of an exemplary nozzle through-hole forming microstructure according to the present invention;

FIG. 22 is a graph showing the change in cross-sectional open area along the height of another exemplary nozzle through-hole forming microstructure according to the present invention;

FIGS. 23A and 23B are a top view and perspective view, respectively, of an exemplary array of nozzle through-hole forming microstructures according to the present invention;

FIGS. 24A and 24B are a side view and perspective view, respectively, of the nozzle through-hole forming microstructure used to form the array of FIGS. 23A and 23B;

FIG. 25 is a photograph of an exemplary fluid plume according to the present invention;

FIG. 26 is a perspective view of a nozzle through-hole forming microstructure according to the present invention having a fluid shearing section similar to that of FIG. 24 with a corresponding counterbore;

FIG. 27 is a perspective view of a nozzle through-hole forming microstructure according to the present invention having an alternative fluid shearing section;

FIG. 28 is a graph showing the change in cross-sectional open area along the height of four exemplary nozzle through-hole forming microstructures according to the present invention;

FIGS. 29A-29C are a side view, front view and perspective view, respectively, of one nozzle through-hole forming microstructure exhibiting the cross-sectional profile of Design 0801 traced on the graph of FIG. 28;

FIG. 30 is a perspective view of an exemplary array of the nozzle through-hole forming microstructure of FIGS. 29A-29C;

FIGS. 31A-31C are a side view, front view and perspective view, respectively, of one nozzle through-hole forming microstructure exhibiting the cross-sectional profile of Design 0802 traced on the graph of FIG. 28;

FIG. 32A is a perspective view of an exemplary array of the nozzle through-hole forming microstructure of FIGS. 31A-31C;

FIG. 32B is a perspective view of the exemplary array of the nozzle through-hole forming microstructures of FIG. 32A with a ring-shaped feature forming a mixing chamber connecting together the outlet openings of the corresponding through-holes;

FIGS. 33A-33C are a side view, front view and perspective view, respectively, of one nozzle through-hole forming microstructure exhibiting the cross-sectional profile of Design 0804 traced on the graph of FIG. 28;

FIG. 34 is a perspective view of an exemplary array of the nozzle through-hole forming microstructure of FIGS. 33A-33C;

FIG. 35 is a graph showing the change in cross-sectional open area along the height of an exemplary nozzle through-hole forming microstructure according to the present invention;

FIGS. 36A and 36B are a side view and perspective view, respectively, of a nozzle through-hole forming microstructure exhibiting the cross-sectional profile of Design 0611 traced on the graph of FIG. 35;

FIG. 37 is a graph showing the change in cross-sectional open area along the height of an exemplary nozzle through-hole forming microstructure according to the present invention;

FIGS. 38A and 38B are a side view and perspective view, respectively, of a nozzle through-hole forming microstructure exhibiting the cross-sectional profile of Design 0611 traced on the graph of FIG. 37;

FIGS. 39A and 39B are each a graph showing the change in cross-sectional open area along the height of alternative exemplary nozzle through-hole forming microstructures according to the present invention;

FIG. 40 is a perspective view of an exemplary array of an alternative nozzle through-hole forming microstructures according to the present invention mounted on a partially spherical base surface;

FIG. 41 is a top view of one of the single outlet opening nozzle through-hole forming microstructures shown in FIG. 40;

FIG. 42 is a perspective view of an exemplary nozzle through-hole forming microstructure according to the present invention having two outlet openings;

FIG. 43 is a perspective view of an exemplary nozzle through-hole forming microstructure according to the present invention having three outlet openings;

FIG. 44 is a perspective view of an alternative nozzle through-hole forming microstructure according to the present invention having two outlet openings;

FIG. 45 is a perspective view of an exemplary nozzle through-hole forming microstructure according to the present invention having two outlet openings similar to that of FIG. 42 with a corresponding counterbore;

FIG. 46 is a perspective view of an exemplary nozzle through-hole forming microstructure according to the present invention having two outlet openings similar to that of FIG. 44 with a corresponding counterbore;

FIG. 47 is a schematic side view of a fuel injector nozzle according to an embodiment of the present invention designed to exhibit conservation of fluid momentum.

### DETAILED DESCRIPTION OF CERTAIN EMBODIMENTS

In describing illustrative embodiments of the invention, specific terminology is used for the sake of clarity. The invention, however, is not intended to be limited to the specific terms so selected, and each term so selected includes all technical equivalents that operate similarly.

The terms “comprises” and variations thereof do not have a limiting meaning where these terms appear in the description and claims.

The words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, “a,” “an,” “the,” “at least one,” and “one or more” are used interchangeably. Thus, for example, a nozzle structure that comprises “a” through-hole can be interpreted to as “one or more” through-holes.

The term “and/or” means one or all of the listed elements or a combination of any two or more of the listed elements.

As used herein, the term “or” is generally employed in its sense including “and/or” unless the content clearly dictates otherwise.

Also herein, the recitations of numerical ranges by endpoints include all numbers subsumed within that range in increments commensurate with the degree of accuracy indicated by the end points of the specified range (e.g., for a range of from 1.000 to 5.000, the increments will be 0.001, and the range will include 1.000, 1.001, 1.002, etc., 1.100, 1.101, 1.102, etc., 2.000, 2.001, 2.002, etc., 2.100, 2.101, 2.102, etc., 3.000, 3.001, 3.002, etc., 3.100, 3.101, 3.102, etc., 4.000, 4.001, 4.002, etc., 4.100, 4.101, 4.102, etc., 5.000, 5.001, 5.002, etc. up to 5.999) and any range within that range, unless expressly indicated otherwise.

The nozzle structures and nozzles incorporating the nozzle structures described herein can, in one or more embodiments, be made using any suitable additive manufacturing techniques (i.e., processes and equipment). Such additive manufacturing techniques may include, for example, the use of single photon, multiphoton, or other net-shape technology. Such additive manufacturing techniques that can be used include, for example, multiphoton (e.g., two photon) techniques, equipment and materials as described, e.g., in U.S. Pat. No. 9,333,598 B2 and US Patent Application Publication No. US 2013/0313339 (both titled “Nozzle and Method of Making Same”), which is incorporated herein by reference in its entirety. Methods of manufacturing the nozzle structures and nozzles incorporating the nozzle structures described herein may also be described in the following co-pending applications: METHOD OF ELECTROFORMING MICROSTRUCTURED ARTICLES, International Patent Application No. PCT/IB2017/058299, based on U.S. Provisional Application No. 62/438,567, filed on Dec. 23, 2016; NOZZLE STRUCTURES WITH THIN WELDING RINGS AND FUEL INJECTORS USING THE SAME, International Application Number PCT/IB2017/058168, based on U.S. Provisional Application No. 62/438,558, filed on Dec. 23, 2016; and MAKING NOZZLE STRUCTURES ON A STRUCTURED SURFACE, International Application Number PCT/IB2017/058315, based on U.S. Provisional Application No. 62/438,561, filed on Dec. 23, 2016, which are each incorporated herein by reference in its entirety.

In one embodiment, multiphoton additive manufacturing processes, equipment and other technology can be used to fabricate various microstructured features, which can include one or more hole forming features that may be used in one or more nozzle structures incorporated to form at least part of a nozzle such as, for example, those used in fuel injectors. Such features can be used to form nozzle structures (or other articles) themselves, they can be used to form intermediate molds that are useful in fabricating nozzle structures (or other articles), or they can be used to form both. Other suitable additive manufacturing process(es) (e.g., electroplating, metal particle sintering, and other additive metal manufacturing processes) can be used with the microstructured feature(s) to form the nozzle structures (or other articles) and intermediate molds. The nozzle structures described herein and any other nozzle structures according to the present invention (e.g., nozzle plates, a valve guide structure or insert formed integrally with a nozzle plate as one piece, a nozzle plate integrally attached to a valve guide structure or insert, etc.) may be constructed of any material or materials suitable for use in a nozzle application (e.g., a nozzle for a fuel injector), such as one or more metals, metal alloys, ceramics, etc. In particular, electroplatable metals and metal alloys can be desirable (e.g., nickel, nickel-cobalt, nickel-manganese, or other nickel-based alloys).

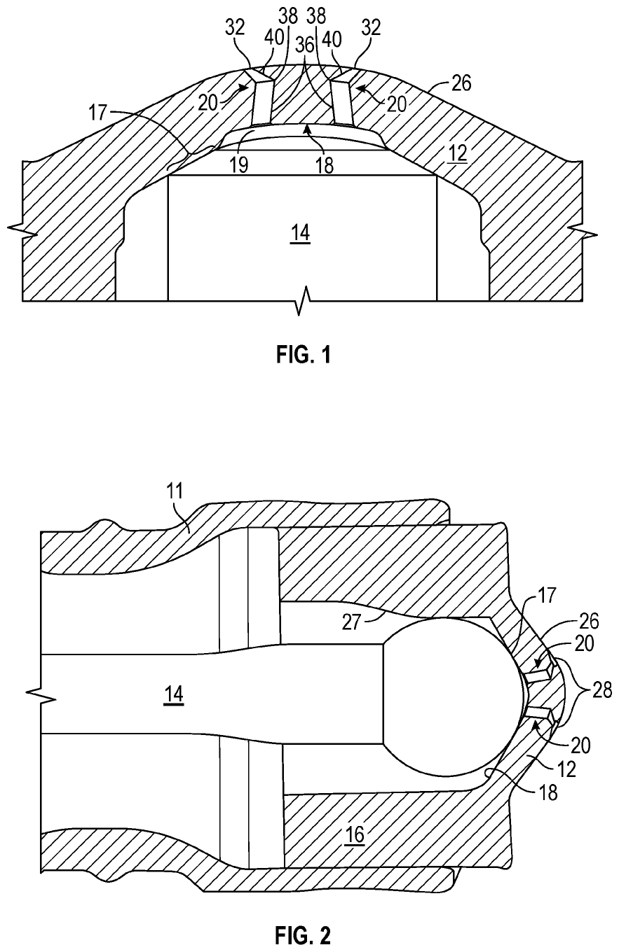

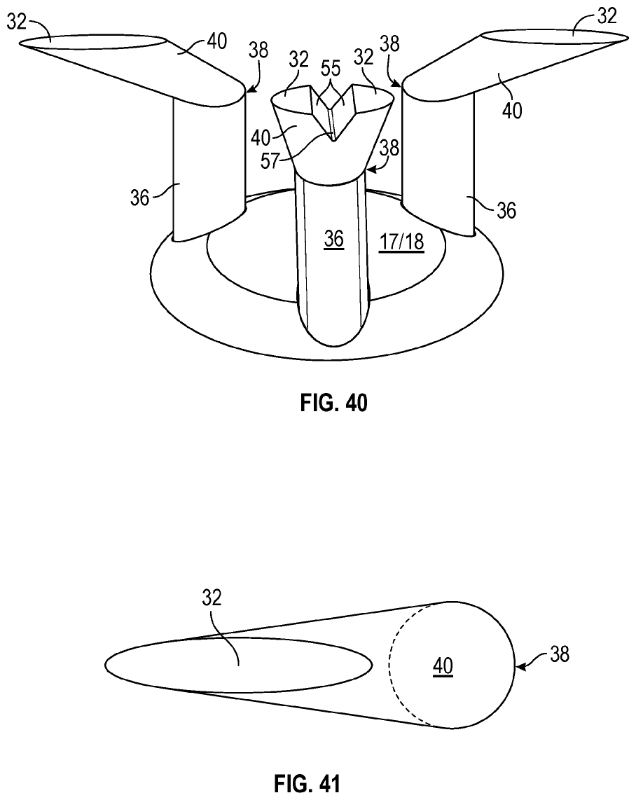

Thus, in one exemplary embodiment of such an additive manufacturing process that can be used in accordance with the present invention, a single-photon or multiple-photon additive manufacturing process could be used to build any desired nozzle related feature (e.g., a negative image of a nozzle through-hole) on a mastering substrate. The mastering substrate has a base surface on which one or more three dimensional microstructured features (e.g., one or more negative image nozzle through-hole structures) are built up, written or otherwise formed onto the base surface. This base surface can be flat or three dimensional and configured to have any shape desired (e.g., configured to have a shape that provides desirable mating between the inlet face 18 of the nozzle structure 12 and the leading end of the valve stem 14 (see, e.g., FIGS. 1 and 2). It can be desirable for the inlet face 18 to be a partially spherical (see, e.g., FIG. 40) or otherwise three-dimensional surface for forming an inlet surface 18 of the nozzle structure 12 that matches, so as to contact, enough of the leading end of the valve stem 14 to reduce or eliminate the space 19 therebetween, when the end of the valve stem 14 contacts the inlet surface 18 so as to cut-off access of the fluid to the nozzle inlet openings 21 of the through-holes 20. After the microstructured features are formed on the base surface, the mastering substrate is subjected to further additive manufacturing processing (e.g., electroplating) to form the desired structure (e.g., a nozzle structure) on top of the base surface so as to surround each microstructured feature and, thereby, form the negative image of those features. Depending on the net shape capabilities of the additive manufacturing processes used (e.g., electroplating, metal injection molding, metal sintering, etc.), the structure formed (e.g., a preformed nozzle structure) may need to have some material removed (e.g., by grinding, EDM, etc.) to produce the finished part. For example, to form a nozzle plate or other nozzle structure from an electroplated nozzle plate preform or other nozzle structure preform, it may be necessary to remove a top portion of the preform in order to expose all of the nozzle through-holes (e.g., to convert blind holes into through-holes or to fully open through-holes).

In general, the pressure of the fluid in the through-hole, the number of through-holes, and each through-hole's internal dimensions can each affect, or even determine, the overall fluid flow rate through the nozzle. Each through-hole's off-axis angle; length (i.e. height), side to side width, thickness, shape and outlet opening cross-sectional area, and its orientation with respect to the other through-holes, can determine the spray plume's (e.g., a cone-shaped plume's) interior and exterior characteristics.

While the following embodiments have not been optimized to a specific application, the through-hole dimensions can be tailored to produce more uniform penetration and the exact plume characteristics desired. Other different through-hole designs can be integrated into an overall nozzle through-hole array design to add features into the spray plume (e.g., a cone-shaped plume) that here-to-fore were unavailable to nozzle designers. For increased targeting or penetration, for example, through-holes can be included that provide separate highly aimed fluid streams or jets. Such fluid streams or jets can be included in the interior or outside the exterior of the spray plume (e.g., a cone-shaped spray plume). In addition or alternatively, some of the through-holes can be redistributed, re-targeted or both, in order to create a desired number of open slit(s) or other spaces in the spray plume. For example, such spaces can be formed in the spray plume (e.g., the wall of a cone-shaped plume) to (a) facilitate air entrainment or to avoid contact between the sprayed fluid and a structure in the combustion chamber (e.g. intake valves, piston surface, chamber wall), (b) change the shape of the spray plume (e.g., to form non-circular cone-shapes), (c) produce off-axis symmetric or non-symmetric spray plume (e.g., cone) shapes that effectively tilt the spray plume (e.g., for side mount applications), (d) etc., and (e) any combination thereof.

The nozzle through-holes and through-hole arrays described herein can be designed to conserve fluid flow energy and minimize back pressure losses, at the point the fluid enters the nozzle and at any point along the fluid flow path, internally within the through-hole(s), until the fluid reaches the point where the energy is needed for fluid stream break-up. It can be desirable to control the degree to which the fluid flow energy is conserved, because the level of fluid flow energy can impact the atomization (i.e., droplet size and distribution) and penetration depth of the fluid stream exiting the through-hole. Therefore, it can be desirable for the nozzle through-holes to have varying degrees of fluid flow energy conservation.

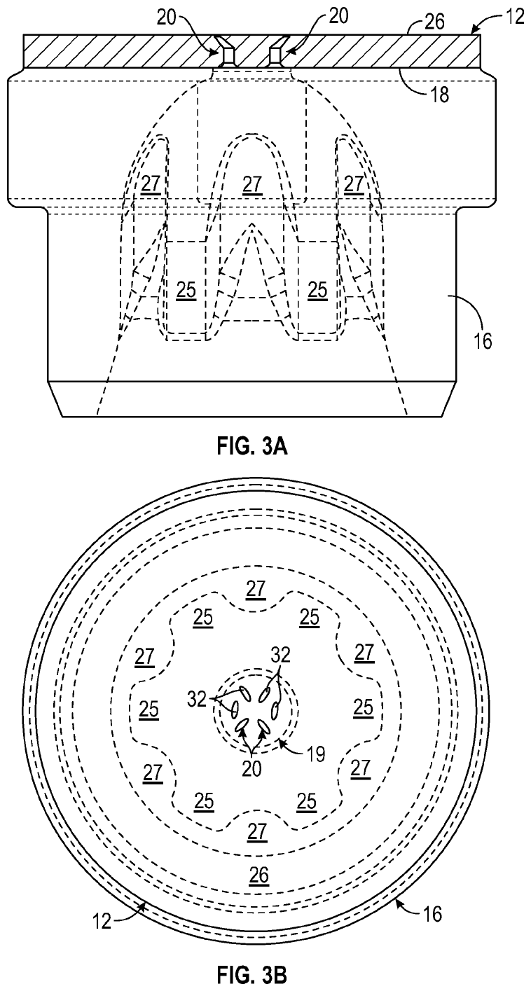

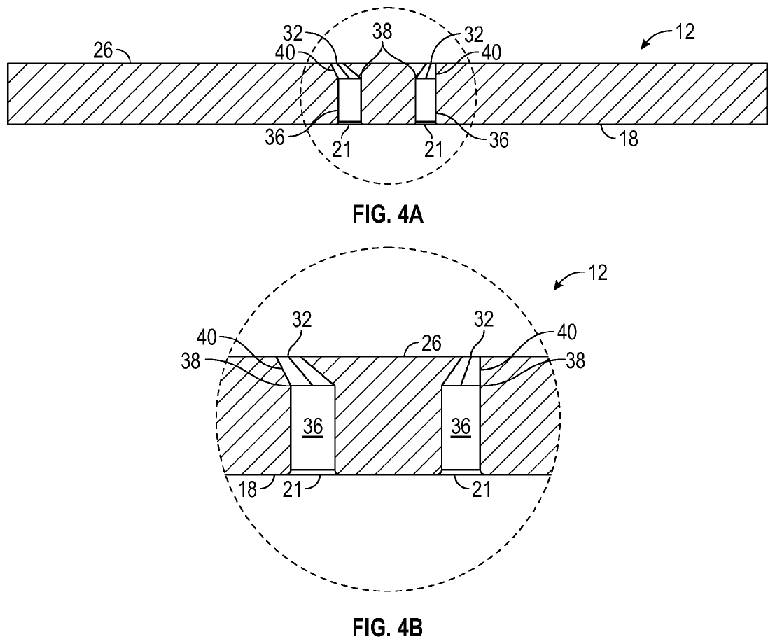

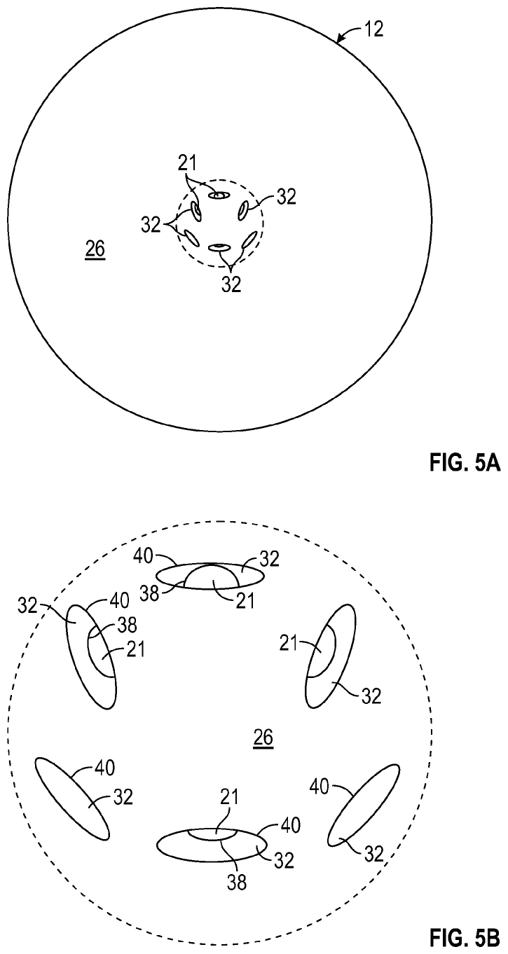

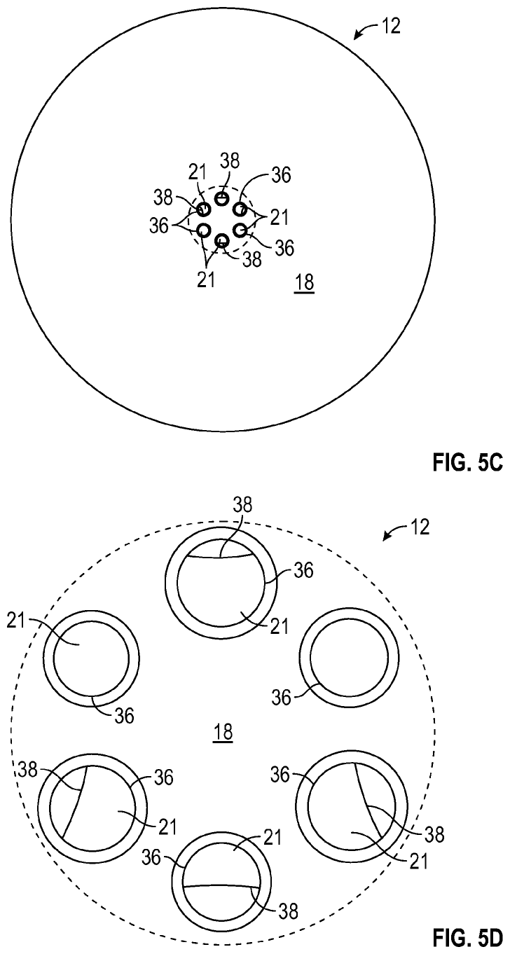

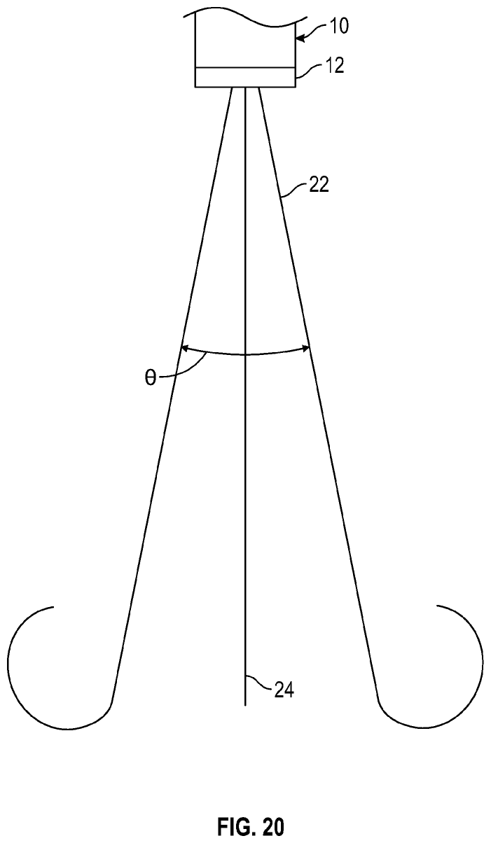

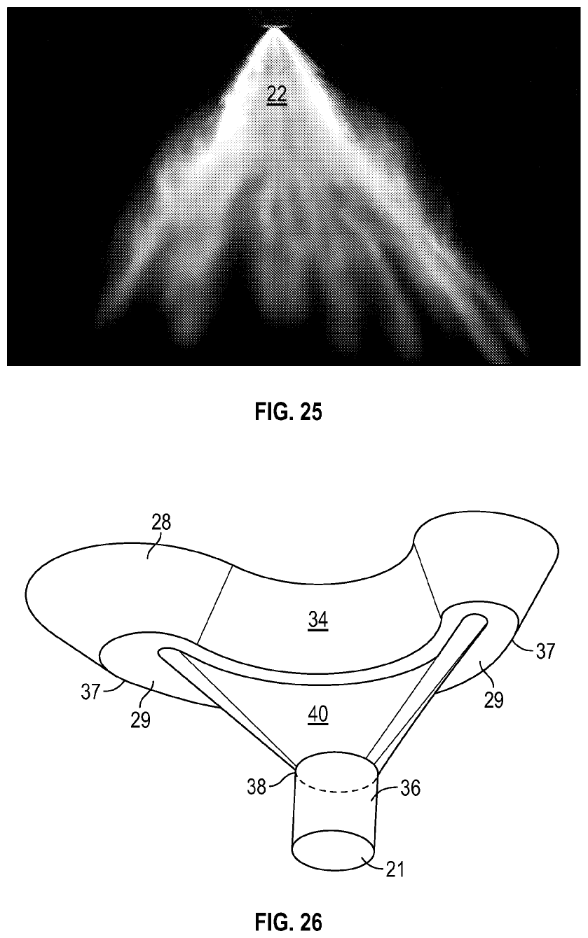

Referring to the Figures herein, a fuel injector nozzle 10, of a fuel injector body 11, includes a nozzle plate or other nozzle structure 12, a valve stem 14 positioned within the fuel injector body 11 so as to engage a valve guide structure or insert 16. The valve guide 16 is either a structure that is formed integrally as one piece with the nozzle plate or other nozzle structure 12, or the valve guide 16 is in the form of a separate insert that is secured (e.g., via welding) to a separate nozzle plate or other nozzle structure 12. The valve guide 16 includes a valve seat region 17 defining a valve guide aperture or opening 19. The valve stem 14 is moved within the injector body 11 and valve guide 16 towards and away from the valve seat region 17. The leading end of the valve stem 14 is guided by a plurality of alternating grooves (commonly referred to as flutes) 25 and ribs 27, formed within the valve guide 16, that circumferentially surround the leading end of the valve stem 14 (see, e.g., FIGS. 2, 3A and 3B). Alternatively, the flutes 25 and ribs 27 can be formed around the circumference of the leading end of the valve stem 14 (see, e.g., FIG. 1). To close the fuel injector, the leading end of the valve stem 14 is moved forwards so as to seat and seal against the valve seal region 17. To open the fuel injector, the leading end of the valve stem 14 is moved backwards so as to separate from the valve seat region 17. In this way, the passage of liquid or gaseoous fluid (e.g., a fuel such as gasoline, diesel fuel, fuel oil, alcohol, methane, butane, natural gas, etc.) through the aperture or opening 19 (i.e., into and out of through-holes 20 formed in the nozzle plate or other nozzle structure 12) can be prevented or allowed. Each nozzle through-hole 20 has an inlet opening 21, an outlet opening 32, and a cavity therebetween. Fluid entering the aperture 19 flows into each through-hole inlet opening 21, passes through each through-hole cavity and exits the nozzle plate or other nozzle structure through the through-hole outlet openings 32 in a desired spray pattern of fluid streams to form a fluid plume like that shown, e.g., in FIGS. 20 and 25). An inlet surface or face 18 of the nozzle plate or other nozzle structure 12 faces the leading end of the valve stem 14 and contacts an outlet end surface of the valve guide 16. The nozzle plate or other nozzle structure 12 defines a thickness between its inlet face or surface 18 and its outlet face or surface 26 in the area occupied by the through-holes 20.

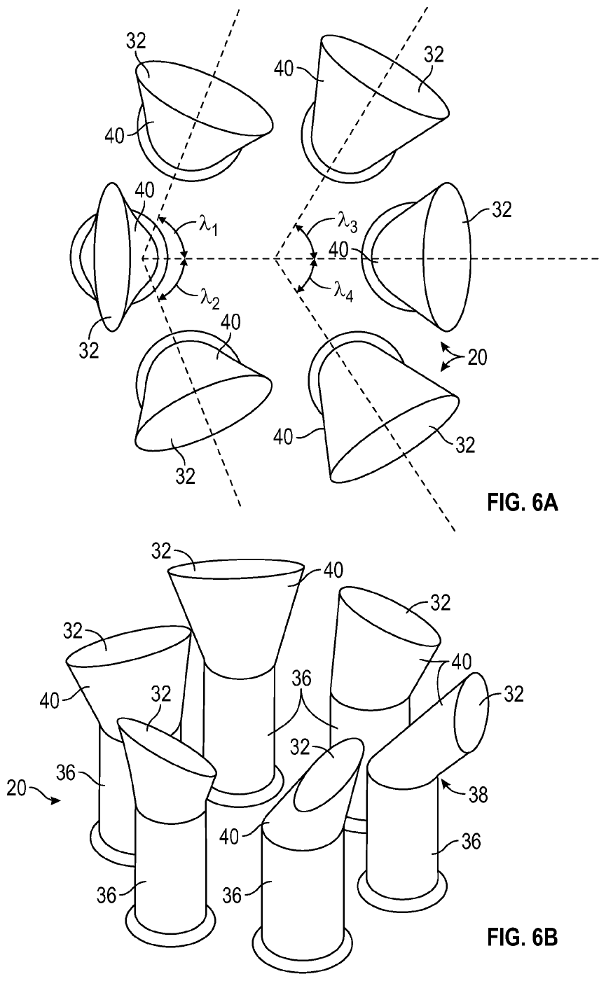

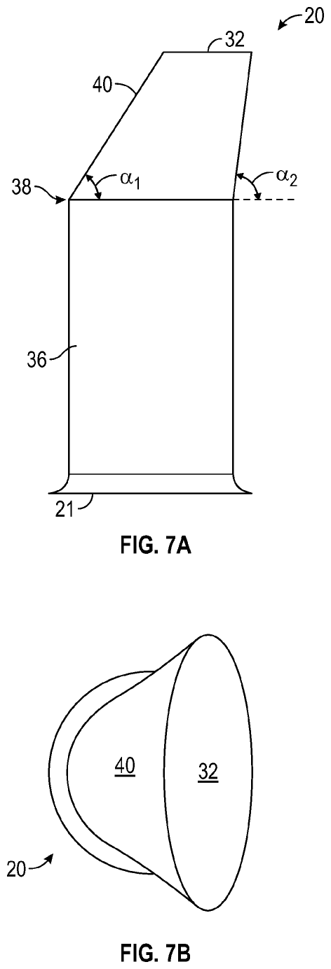

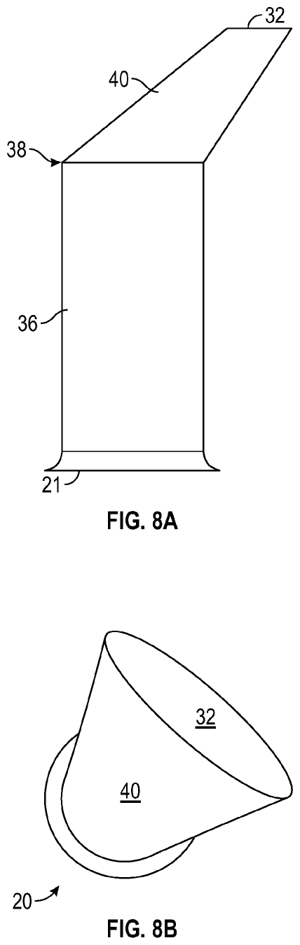

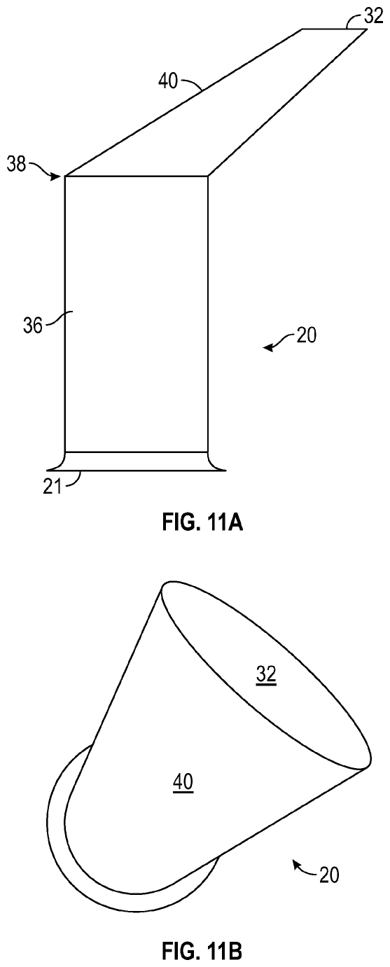

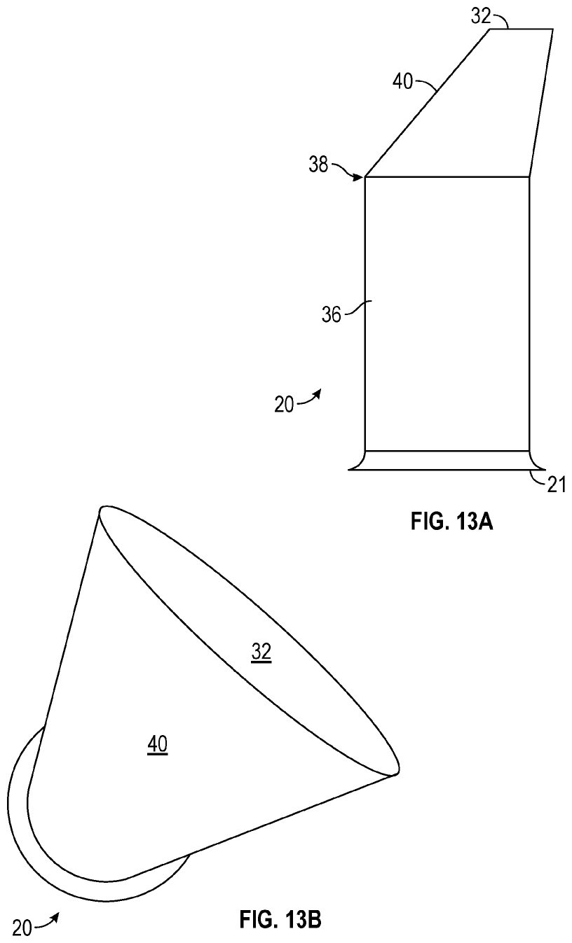

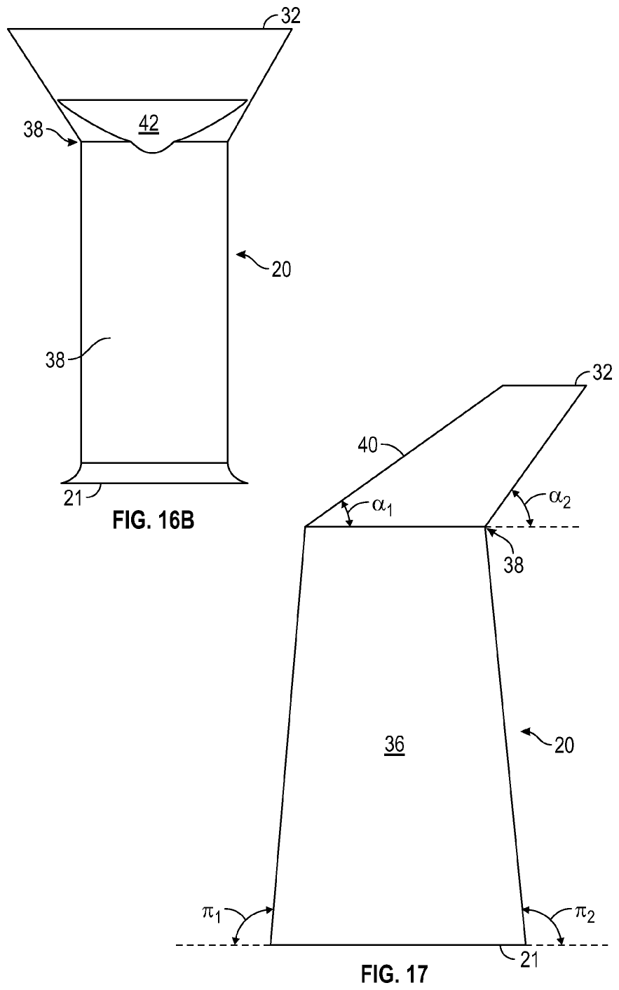

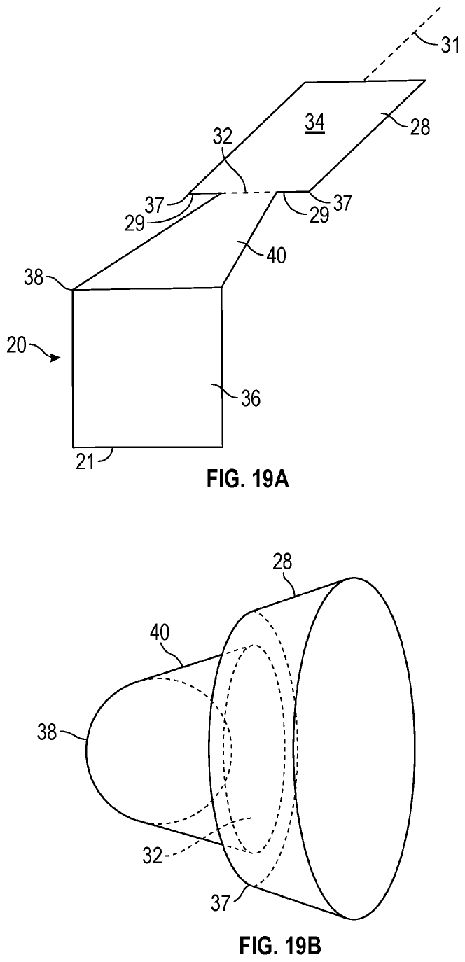

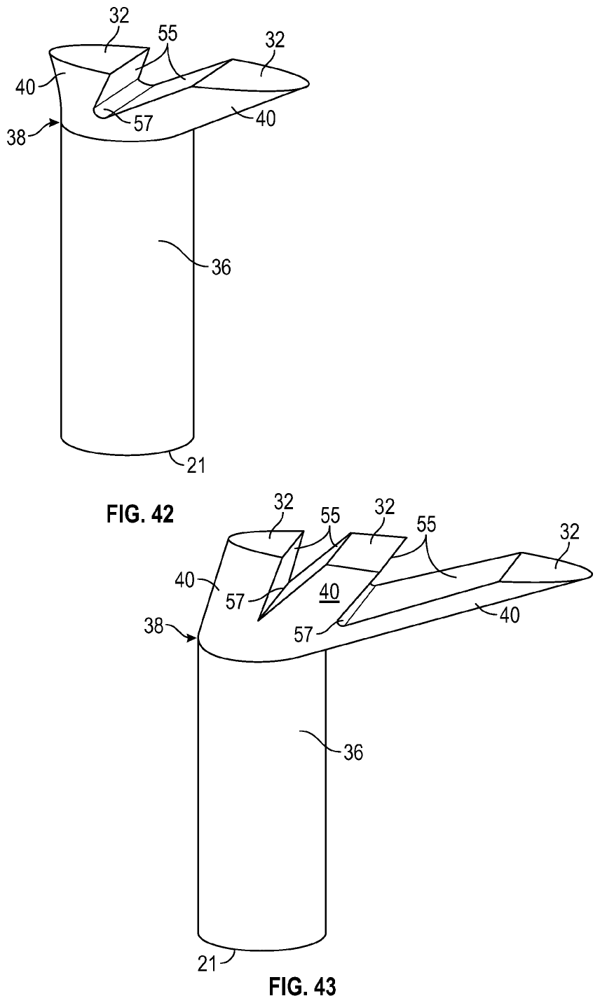

While the through-hole array illustrated in FIGS. 6A and 6B is formed using six through-holes 20, the present invention is not limited to arrays made with any particular number or configuration or orientation of through-holes 20 (see, e.g., FIGS. 23, 30, 32, 34 and 40). For example, FIG. 6A includes an orientation plane (the dashed lines) for each through-hole 20 that is aligned so as to pass through the center (e.g., the central axis of the section 36, section 38 and/or section 40) of each through-hole 20, with these orientation planes forming angles λ with each other. In the FIG. 6A embodiment, there are four angles λ₁, λ₂, λ₃ and λ₄ of equal magnitude. The fluid plume to be formed can determine the number of through-holes 20 used, the relative orientation of those through-holes, and the configuration of each through-hole 20 used in the array. So, each of the angles λ₁, λ₂, λ₃ and λ₄ can be the same or different or any desired combination. The through-holes 20 made using the microstructures 20 illustrated in FIGS. 7-19, 24, 26, 27, 29, 31, 33, 36, 38, and 40-46 are examples of some of the various through-holes 20 that can be used to form a through-hole array in accordance with the present invention.

Fluid passing through the through-holes 20 exits the nozzle plate or other nozzle structure in a desired spray pattern of fluid streams to form a fluid plume. The spray pattern or plume 22 is preferably formed around a central axis 24 (see, e.g., FIG. 20). In one or more embodiments, the spray pattern or plume 22 may define the central axis 24 which may, in one or more embodiments, be described as being formed within a center of the spray pattern or plume 22 formed by multiple fluid streams exiting the nozzle plate or other nozzle structure 12 as described herein. The center of the spray pattern or plume 22 can be defined by the center of the volume occupied by the droplets forming the spray pattern or plume 22 in the direction along which the fluid is moving (i.e., downstream).

Each through-hole includes at least a fluid shearing section and an optional transition region. It can be desirable for one or more or all of the through-holes to be divided into three portions along the direction of fluid flow: an initial section in fluid communication with the inlet opening of the through-hole, the fluid shearing section in fluid communication with the outlet of the through-hole, and the transition region that provides fluid communication between the initial section and the fluid shearing section.

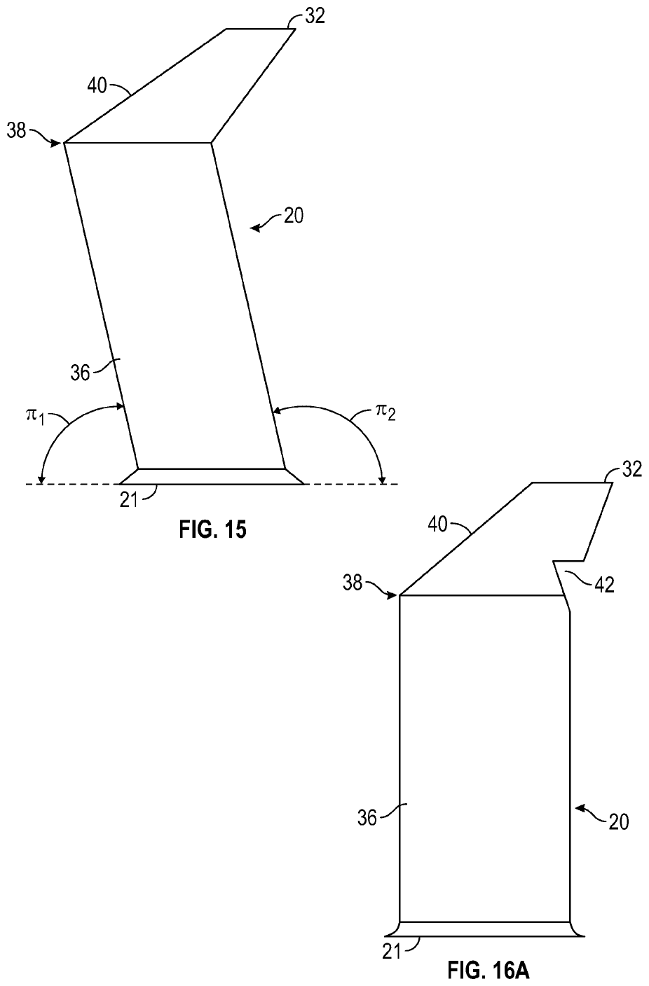

The optional initial section can be, and preferably is, where the fluid enters the through-hole. A leading-edge fillet (e.g., having a radius of curvature or other gradually sloping region) can be formed at the inlet opening of the through-hole (e.g., in one embodiment, the edge forming the inlet opening of the through-hole forms the entrance to the initial section and is radiused or otherwise gradually sloping) to allow smoother laminar flow into the through-hole, as compared to a sharp or otherwise abrupt transition. Such a leading-edge fillet can minimize turbulence of the fluid entering the through-hole and, thereby, conserve the fluid's potential energy until needed for the fluid shearing process. The initial section can be tilted off-axis at an acute or obtuse angle π from the inlet surface of the nozzle structure adjacent to the through-hole inlet opening (see, e.g., FIGS. 15) to maintain the incoming fluid's momentum, to begin the process of fluid spray stream targeting, or both. It may also be desirable to increase turbulence in the initial section, in order to increase atomization or otherwise break-up the fluid stream exiting the through-hole. For example, it is believed that shortening the length of the initial section can reduce laminar flow within the initial section and increase atomization or the break-up of the exiting fluid stream. It may also be desirable to completely eliminate the initial section of the through-hole, for example, in order to increase the amount of turbulence in the fluid flowing through the through-hole.

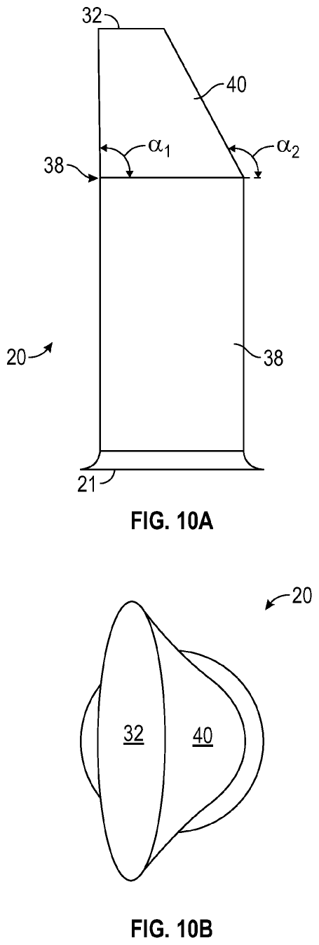

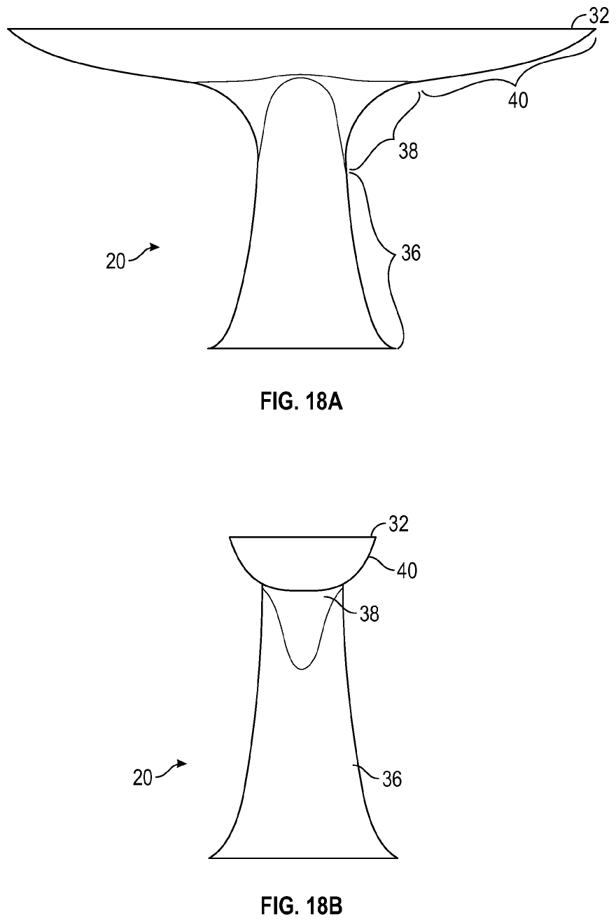

Opposite interior sidewalls of the initial section 36, can be converging towards each other (see, e.g., FIGS. 17 and 18) or diverging away from each other, as well as parallel to each other (see, e.g., FIG. 10A). For example, these opposite interior sidewalls can be inclined at the same or different angles π from the from the inlet surface of the nozzle structure adjacent to the through-hole inlet opening. The angles π can include an angle π₁ and an angle π₂, where π₁ is equal to π₂ or not, π₁ is less than π₂, or π₁ is greater than π₂. The angles π can each be acute angles, obtuse angles or one acute and one obtuse. In addition, one of the angles π can a right angle and the other an obtuse or acute angle π.

The transition region is a point or sub-length along the through-hole length where the fluid within the through-hole transitions into the fluid shearing section. This transition region is not necessarily at the halfway point along the length of the through-hole or half-way through the nozzle structure thickness. The transition region can be positioned almost anywhere along the fluid flow path within the through-hole. It is desirable to position the transition region where fluid turbulence needs to be generated, in order to optimize the desired break-up (i.e., fluid droplet size and depth of penetration beyond the through-hole outlet opening) of the fluid stream exiting the through-hole. This turbulence can generate perforations and/or waves in the fluid passing through the fluid shearing section to assist in the break-up of the fluid stream exiting the through-hole. One or more separate cavitation features can also be included on the interior surface of the through-hole cavity within the initial section, the transition region, or the fluid shearing section. One or more cavitation features may also overlap any one or more or all of the initial section, the transition region and the fluid shearing section. It may also be desirable to completely eliminate the initial section and/or the transition region of the through-hole, for example, in order to increase the amount of turbulence in the fluid flowing through the through-hole.

The fluid shearing section transforms the fluid flowing through the through-hole into a transversely elongated or sheared stream having a flattened (e.g., sheet-like, fan blade-like, etc.) shape. In one embodiment, the fluid shearing section can be configured to create a fluid stream or spray pattern that spreads out in a direction transverse to the direction of fluid flow, where the side to side width of the fluid stream increases (i.e., the side edges of the fluid stream diverge), stays the same (i.e., the side edges of the fluid stream are generally parallel to each other), or possibly even decreases (i.e., the side edges of the fluid stream converge), the further away the fluid stream gets from the through-hole outlet opening. In one embodiment, the fluid shearing section has a cross-sectional shape with a major axis and a minor axis, and these axes are dimensioned so as to provide the shearing of the fluid flowing therethrough. For example, the length of the major axis can increase, stay relatively the same, or possibly even decrease, from the upstream end to the downstream end of the fluid shearing section. In addition, the length of the minor axis can decrease, stay relatively the same, or possibly even increase, from the upstream end to the downstream end of the fluid shearing section.

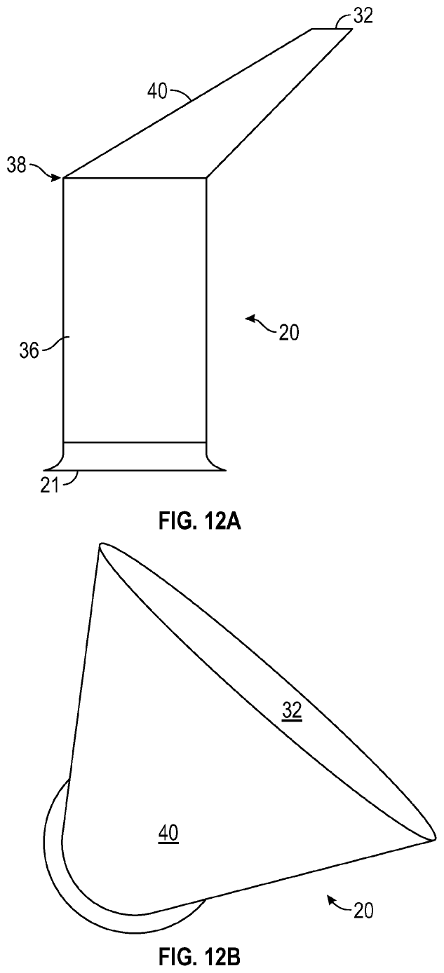

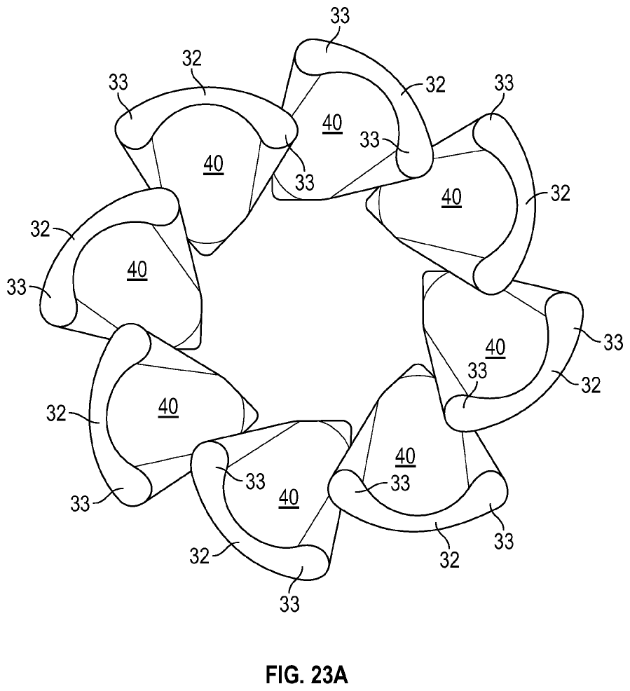

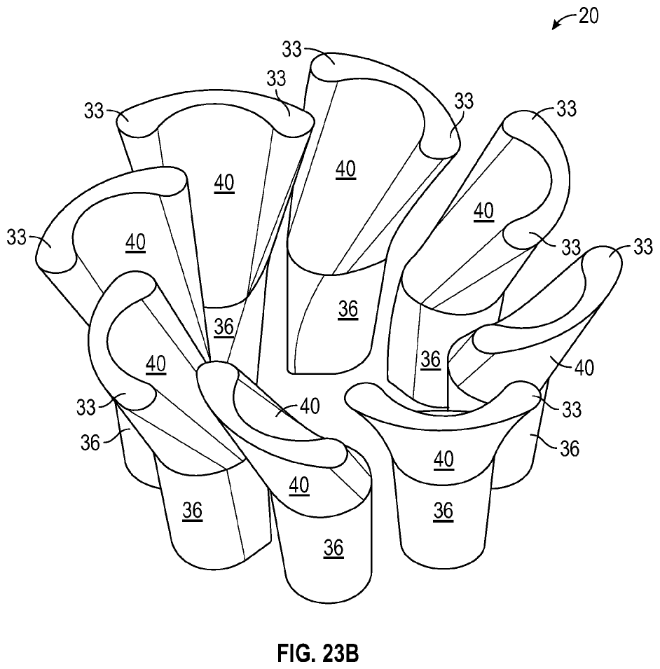

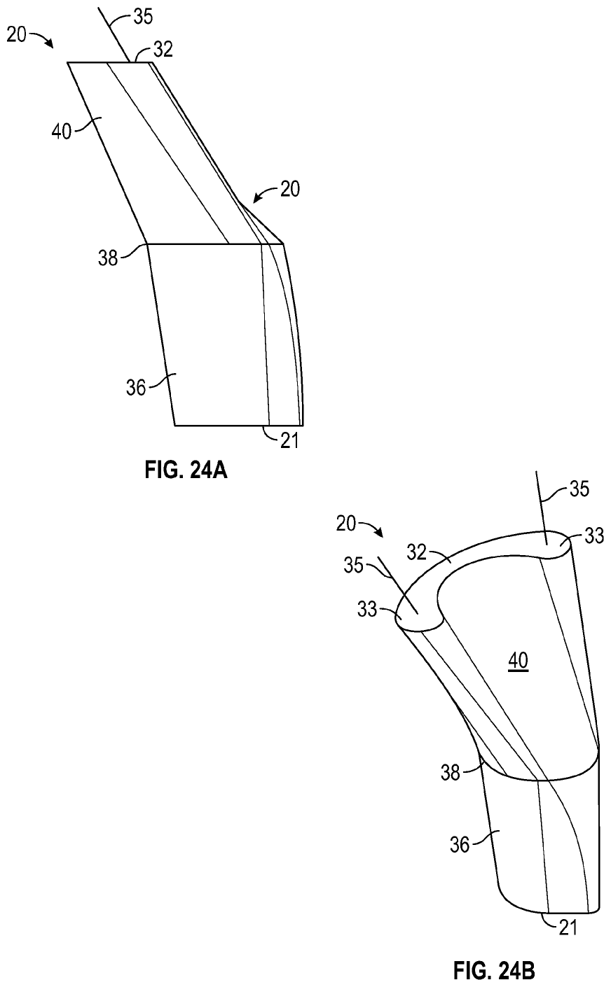

The effective side to side width of the fluid stream exiting a through-hole 20 can be increased by increasing the width (e.g., the length of the major axis) of the through-hole outlet opening 32 and/or by increasing the angle that separates the diverging sides of the shearing section 40. Increasing the effective side to side width of the exiting fluid stream, as the stream moves further from the nozzle, can result in a decrease in the thickness (e.g., the length of the minor axis) of the fluid stream, which can decrease the size of the droplets forming the exiting fluid stream. It is believed that the degree to which shearing (e.g., transverse shearing) of the exiting fluid stream occurs would not be significantly different for two outlet openings having the same major axis length and minor axis width but with the one major axis being a relatively straight line (see, e.g., FIGS. 12B, 14B, 36B and 38B) and other major axis being a crescent shaped line (see, e.g., FIGS. 24B, 27, 31C and 33C).

In one embodiment, the through-hole of the present invention can have a diverging to converging cavity (i.e., a diverging initial section and a converging fluid shearing section), and in another embodiment, the through-hole of the present invention can have a converging to diverging cavity (i.e., a converging initial section and a diverging fluid shearing section).

In general, the cavity of a diverging/converging through-hole has an internal cross-sectional opening, perpendicular to the major direction of fluid flow (i.e., a cavity internal cross-sectional opening), that diverges (i.e., the length in at least one cross-sectional direction, or the cross-sectional area, increases further away from the inlet opening) in the initial section and then, at or after the transition region, the through-hole cavity has an internal cross-sectional opening, perpendicular to the major direction of fluid flow (i.e., a cavity internal cross-sectional opening), that converges (i.e., the length in at least one cross-sectional direction, or the cross-sectional area, decreases further away from the inlet opening) in the fluid shearing section.

In one diverging/converging through-hole embodiment, the internal cross-sectional opening of the initial section cavity diverges (i.e., the length in at least one cross-sectional direction, or the cross-sectional area, increases further away from the inlet opening) up to the transition region at a linear rate of change and then the internal cross-sectional opening begins converging at a non-linear exponential rate in the fluid shearing section. In another diverging/converging through-hole embodiment, the internal cross-sectional opening of the initial section cavity diverges (i.e., the length in at least one cross-sectional direction, or the cross-sectional area, increases further away from the inlet opening) up to the transition region at a non-linear exponential rate of change and then the internal cross-sectional opening begins converging at a non-linear, exponential rate. In either of these two embodiments, the internal cross-sectional area of the initial section can exhibit an increase in internal cross-sectional area, in the range of from about a 5.0% up to about a 50.0%, and preferably in the range of from about a 15.0% up to about a 40.0%, from the through-hole inlet opening to the point of maximum divergence within the initial section.

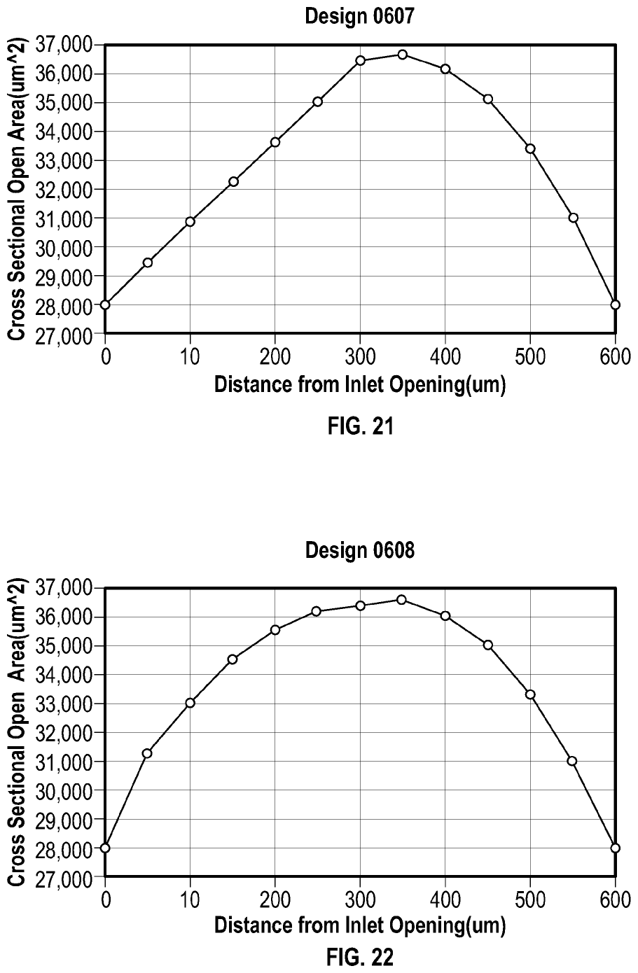

Design 0607 in FIG. 21 illustrates a linear open area change rate up to the transition point where it begins converging at a non-linear, exponential rate. Design 0608 in FIG. 22 illustrates both diverging and converging at an exponential rate. In these two examples, the open area at the maximum divergent point is approximately an 30% increase from the inlet area.

Any combination of diverging and converging rate changes in the cavity internal cross-sectional opening (i.e., the length in at least one cross-sectional direction, or the cross-sectional area) can be designed into a through-hole to match the nozzle's specific application. Any diverging or converging rate change in the cavity internal cross-sectional opening can occur anywhere within the nozzle through-hole. The rate of change at the transition region may impact the nozzle's durability. A rapid change may cause excessive cavitation within the through-hole and result in premature erosion of the interior surface of the through-hole cavity.

In one or more embodiments, the nozzle structures with through-holes as described herein may form cone-shaped fluid plumes that may be useful in, for example, delivering fuel into the combustion chamber of an internal combustion engine. As used herein, the term “cone-shaped fluid plume” refers to the shape of the fluid, after the fluid exits the nozzle structure. It is believed this fluid droplet distribution has a higher concentration of droplets around the outer periphery, than in the center, of the cone-shaped portion of the plume.

The cone-shaped plumes can be hollow or filled with fluid droplets and/or streams. When viewed in cross section, along a plane that passes through the central longitudinal axis of the cone-shaped fluid plume, generally perpendicular to the outlet face or surface of the nozzle structure, it can be desirable for opposite sides of the cone-shape to form an angle θ therebetween in the range of from at least about 25° up to and including about 135°. The cone-shaped portion of the plume can be generally hollow (i.e., less than 25% of the space within the wall of the cone-shaped portion contains the fluid), or the space within the wall of the cone-shaped portion can have a fluid content of at least 25% up to less than 50%, greater than or equal to 50%, or at least 75%. FIG. 22 depicts one illustrative cone-shaped plume forming an angle θ between its opposing sides or edges that may be formed using a nozzle structure having a through-hole that opens onto an outlet face or surface of nozzle structure, with the depicted cone-shaped plume being positioned around central axis.

When the cone shape of the fluid plume is a hollow cone-shaped fluid wall, it can be desirable for the wall to be continuous or discontinuous. The cone-shaped fluid wall is considered continuous, when all or most (i.e., greater than 30%, 35%, 40%, 45%, 50%, 55%, 60%, 65%, 70%, 75%, 80%, 85%, 90%, or 95%) of any fluid droplet or stream makes contact with or is in close proximity to at least one other fluid droplet or stream. A given fluid droplet or stream is in close proximity to another droplet or stream when the gap between them is less than the diameter of the given fluid droplet or stream. The cone-shaped fluid wall is considered discontinuous, when all, most (i.e., greater than 50%, 55%, 60%, 65%, 70%, 75%, 80%, 85%, 90%, or 95% and up to but not including 100%) or a substantial amount (i.e., greater than 10%, 15%, 20%, 25%, 30%, 35%, 40%, or 45% and up to and including 50%) of any fluid droplet or stream is not in close proximity to another droplet or stream.

When the fluid is a fuel for an internal combustion engine, the term “cone-shaped plume” refers to the shape of the fuel, after it exits the through-holes and before it is combusted in the combustion chamber of the engine. It can be desirable for the internal combustion engine to be, e.g., a gasoline direct injection (GDI) engine or another type of direct injection (DI) engine.

In one embodiment of the present invention, shown in FIGS. 23 and 24, the nozzle made from the illustrated array of nozzle through-hole forming microstructures can be used to make a cone-shaped spray pattern or plume 22, like that shown in FIG. 25. In this embodiment, each of the plurality of nozzle through-holes 20 formed from this microstructure array is designed to produce a segment of the cone-shaped spray pattern or plume 22 and these segments are targeted and oriented to result in a single hollow cone-shaped spray plume. Such a cone-shaped spray plume is comparable to that made using conventional nozzle technology, like the spray plume made using the more complicated and expensive piezoelectric fuel injector. The fluid spray pattern or plume 22 of FIG. 25 was generated using a nozzle having an eight (8) through-hole array made using the microstructure array of FIGS. 23A and 23B, with each through-hole microstructure 20 (see FIGS. 24A and 24B) forming a corresponding diverging to converging cavity. The downstream end of the fluid shearing section 40, of the through-hole formed from the microstructure 20 of FIGS. 24A and 24B, has a crescent-shaped outlet opening 32, but this crescent shape is optional. Alternative outlet opening shapes for the through-holes of the present invention, including that of FIGS. 24A and 24B, are illustrated in the figures herein.

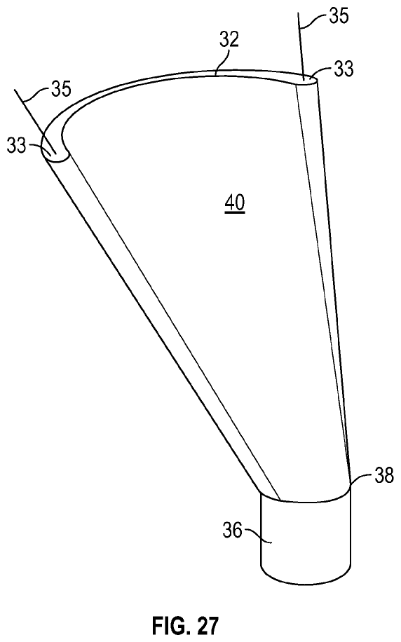

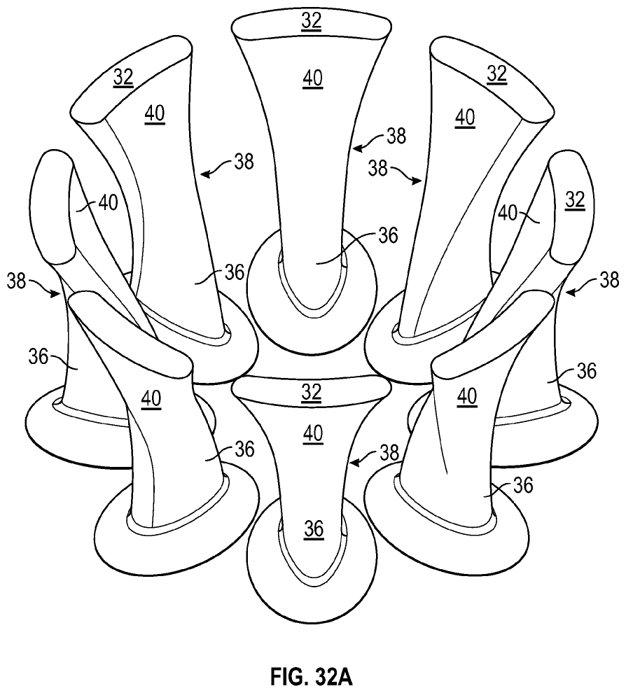

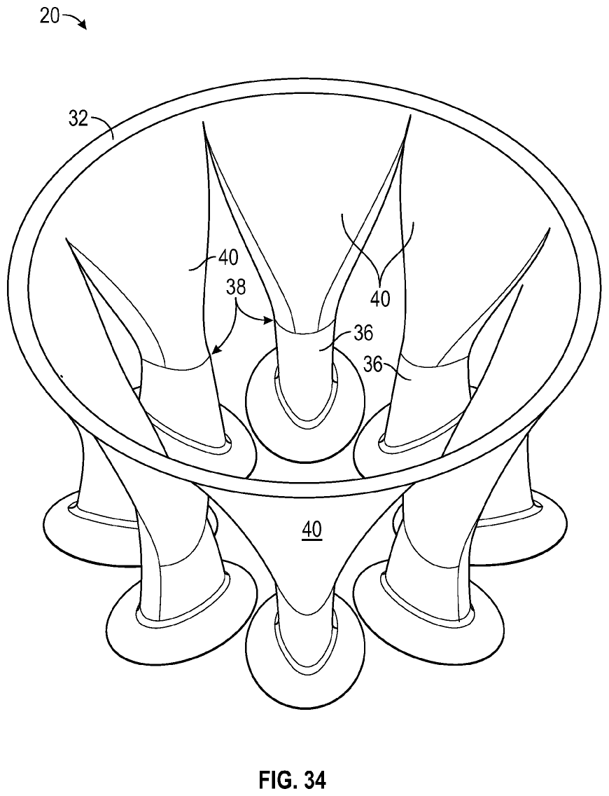

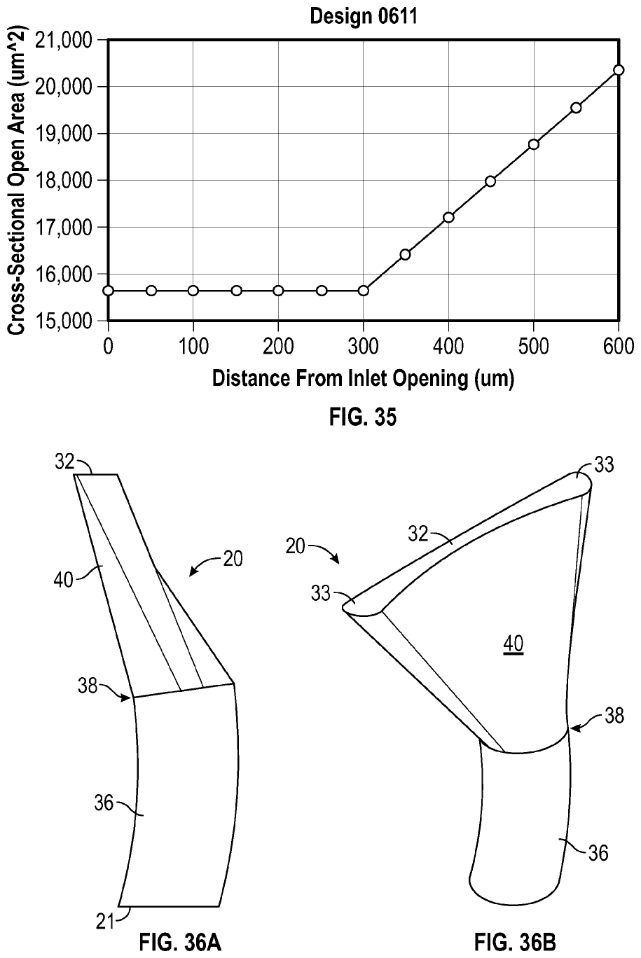

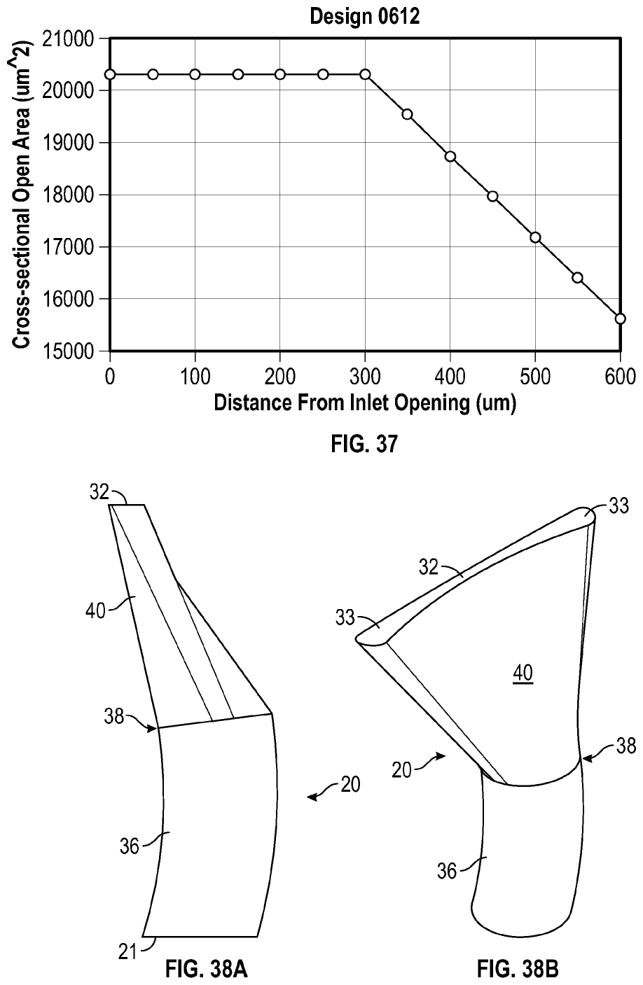

The downstream end of the fluid shearing section 40, of the through-hole formed from each microstructure 20 of FIGS. 24, 27, 29, 31, 32, 33, 36, and 38, has an outlet opening 32 designed to create a relatively thin walled fluid sheet that diverges as it exits and travels away from the nozzle. The particular crescent shaped outlet opening 32, formed from the microstructures of FIGS. 24A and B, includes a node 33 that forms a wider opening at either end of the through hole 32. The end nodes 33 can be any desired shape and are optional. These end nodes 33 can, but are not necessarily required to, establish radial flow lines at the edges of the fluid sheet to assist in creating a lateral shear force perpendicular to the direction of fluid flow out from the nozzle. This lateral shear tears the exited fluid sheet apart as it travels away from the nozzle. Turbulence created in the transition region can create perforations in the thin fluid wall, this coupled with the lateral shear force can increase the rate of disintegration of the fluid film into small droplets. Two outlet fluid flow lines or vectors 35 are shown in FIGS. 24A and 24B to illustrate the diverging paths followed by the fluid exiting the ends of the outlet opening 32 (see also FIG. 27). When these vectors 35 are applied to a microstructure array (e.g., of FIGS. 23A and 23B), it is clear that the orientation of the corresponding eight through-hole forming microstructures 20 results in no intersecting flow lines or vectors 35 for all eight of the resulting through-holes. This orientation was selected to create overlap between the fluid streams exiting the through-hole outlet openings 32, while minimizing coalescence between adjacent fluid streams. When such vectors 35 are applied to the microstructure arrays of, for example, FIGS. 32A, 32B and 34 (not shown), it is clear that the flow lines 35 will intersect and result in the coalescence of adjacent fluid streams.

Video frame stills (not shown) of the fluid spray pattern or plume 22 of FIG. 25 were taken from the start-of-injection and at approximately 10 mm, 20 mm, 30 mm, 40 mm, and 50 mm away from the outlet face 26 of the injector nozzle 10 and synchronized with an X-Y plane patternation at about the same distance. From the patternations (not shown), the hollow cone interior can be seen. In addition, the location and configuration of the eight (8) high flux regions in the corresponding flow patterns 22 indicate that the size and closeness of the end nodes 33 of the through-hole design may cause coalescence of the fluid flowing from adjacent end nodes 33 of each set of two (2) adjacent through-holes. This in turn indicates that the size, shape, alignment and targeting of these through-holes 20 can be adjusted to create a more uniform fluid spray pattern or plume 22.

Comparing the start-of-injection spray plumes 22 to the fully developed plume 22 of FIG. 25 indicates that as the shape of the hollow fluid cone is established, the air pressure within the hollow cone decreases, and as a result, the spray cone angle decreases (i.e., the side to side width of the basic cone shape becomes narrower). As the fluid stream breaks up, the small droplets lose their momentum and curl back towards the nozzle resulting in both filling the center of the hollow fluid cone and effectively widening the outer regions at the leading end of the plume. The narrowing of the fluid cone angle 0, may be affected by designing in one or more slots or other openings into the perimeter of the spray pattern or plume 22, to decrease the pressure drop within the hollow cone and thereby minimize spray angle changes. One or more such slots or other openings can be produced, e.g., by reducing the number of through-holes 20 (e.g., by removing one or more of the eight through-hole forming microstructures in the array of FIGS. 23A and 23B) or by increasing the space between two adjacent through-holes/microstructures 20 or the space between multiple adjacent through-holes/microstructures 20. This technique of providing such slots or other openings into the perimeter of the spray pattern or plume 22 may be desirable for plume shapes other than the illustrated cone-shape. The flow rate of fluid flowing out of a nozzle through-hole 20 (e.g., the nozzle through-holes formed by the exemplary microstructures disclosed herein) may be reduced, and the velocity of the fluid increased, by reducing the cross-sectional area of the through-hole outlet opening 32. At the same time, the penetration and uniformity of the resulting fluid stream exiting the through-hole 20 can be independently adjusted or modified by changing the shape of the through-hole cavity (e.g., the shape of the through-hole outlet opening 32).

In general, the cavity of a converging/diverging through-hole can have an internal cross-sectional opening, perpendicular to the major direction of fluid flow (i.e., a cavity internal cross-sectional opening), that converges (i.e., the length in at least one cross-sectional direction, or the cross-sectional area, decreases further away from the inlet opening) in the initial section and then, at or after the transition region, the through-hole cavity has an internal cross-sectional opening, perpendicular to the major direction of fluid flow (i.e., a cavity internal cross-sectional opening), that diverges (i.e., the length in at least one cross-sectional direction, or the cross-sectional area, increases further away from the inlet opening) in the fluid shearing section. Because it converges, the initial section changes the potential energy of the fluid in the initial section into kinetic energy by increasing the flow velocity of the fluid reaching the transition region and releasing the potential energy in the form of turbulence in the transition region and fluid shearing section of the through-hole.

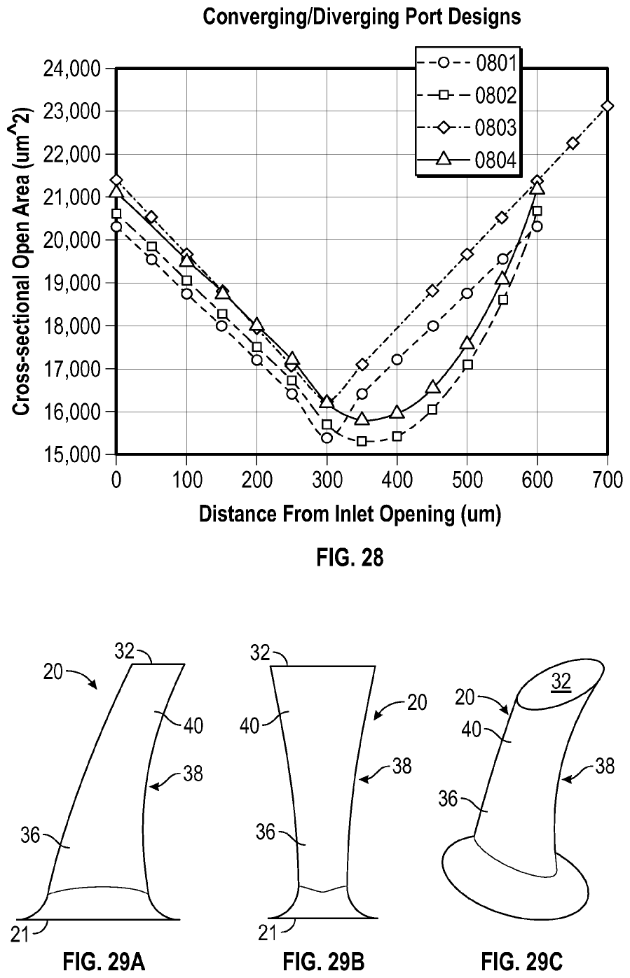

Exemplary converging/diverging embodiments are shown graphically in FIG. 28, with the cross-sectional profiles of Designs 0801, 0802, 0803 and 0804. The traces on the graph of FIG. 28 have been separated vertically by a constant for ease of illustration. The through-hole Designs 0801, 0802, 0803 and 0804 are described below. In general, each of these through-holes 20 have a fluid shearing section 40 with a major axis length at the upstream end of section 40 that converges to a minor axis length at the downstream end of section 40, and a minor axis length at the upstream end of section 40 that diverges to a major axis length at the downstream end of section 40.

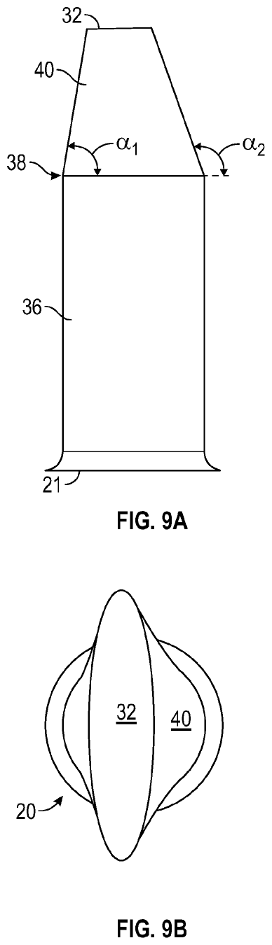

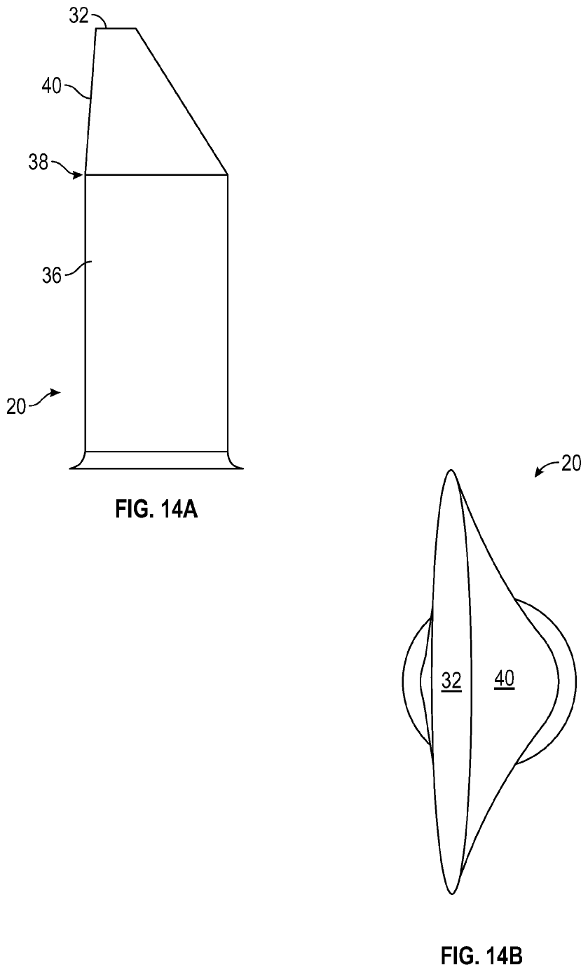

The fluid shearing section 40 can have opposite interior sidewalls, at either end of its minor axis length, that converge toward each other or diverge away from each other. For example, these opposite interior sidewalls can be inclined at the same or different angles a from the cross-sectional plane of the transition region (i.e., at the location of the transition region when it is located at a point along, or at the downstream end of the transition region when it spans over a sub-length of, the through-hole length). The angles α can include an angle α₁ and an angle α₂, where α₁ is equal to α₂ or not, α₁ is less than α₂ (e.g., see FIG. 7A), or α₁ is greater than α₂ (e.g., see FIG. 9A). The angles α can each be acute angles, obtuse angles or one acute and one obtuse (e.g., see FIG. 14A). In addition, one of the angles α can be a right angle and the other an obtuse angle α (e.g., see FIG. 10A).

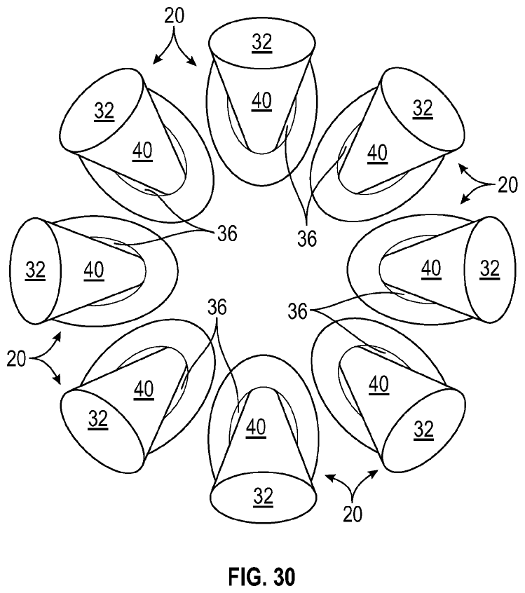

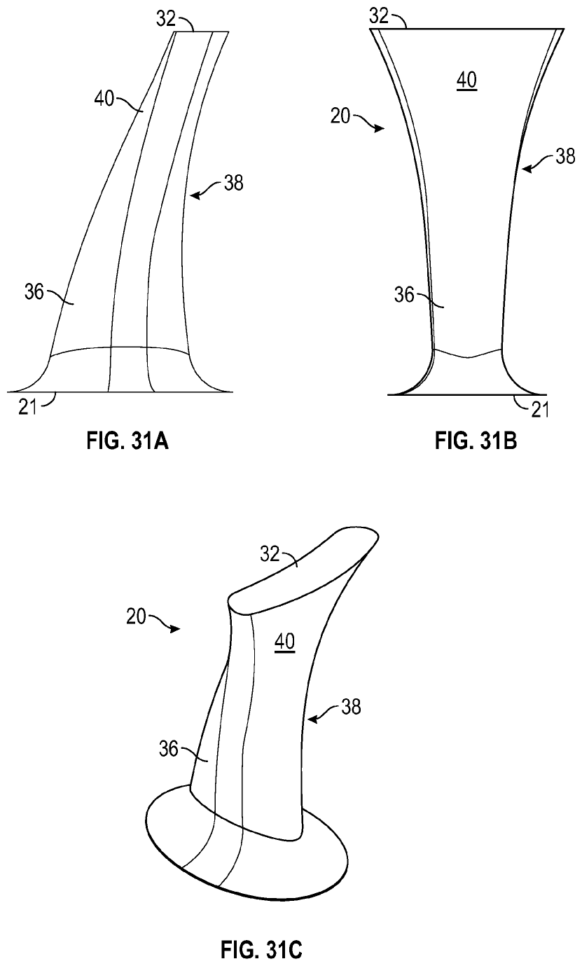

The cross-sectional profile of through-hole Design 0801, has a linear converging and diverging rate of change, a total fluid path length of 600 μm with the transition region located midway at 300 μm. The side, edge and perspective views of the 0801-through-hole design (including an inlet fillet) are shown in FIGS. 29A-29C, respectively. A nozzle through-hole array design is shown in FIG. 30, which uses eight (8) through-holes 20 of the Design 0801 of FIGS. 29A-29C. Even when two nozzle through-hole array designs have the same inlet and outlet open area and the same through-hole positioning, if the through-holes 20 of one of the array designs has a 20° rotation, compared to the other array design, the fluid stream to fluid stream interaction between adjacent outlet openings will be different, and can result in very different fuel spray pattern or plume characteristics. The profile of through-hole Design 0803 is virtually identical to the 0801-through-hole design; except the Design 0803 is 100 μm taller (requiring a thicker nozzle structure 12) and has a total length of 700 μm with a transition region located at 300 μm. The through-hole Design 0802 is shown in FIGS. 31A-31C and has a linear converging and an exponential diverging rate, total length of 600 μm with the transition region located at 300 μm. While the converging inlet section of Design 0802 is virtually identical to Design 0801; the transition regions 38 and fluid shearing sections 40 are different. FIGS. 32A and 32B (side and perspective views) show an array of nozzle through-hole forming microstructures 20 using eight (8) Design 0802 through-holes layed-out in a circle like the previously described eight hole array of nozzle through-hole forming microstructures. In the embodiment of FIG. 32A, the through-holes 20 remain separated.

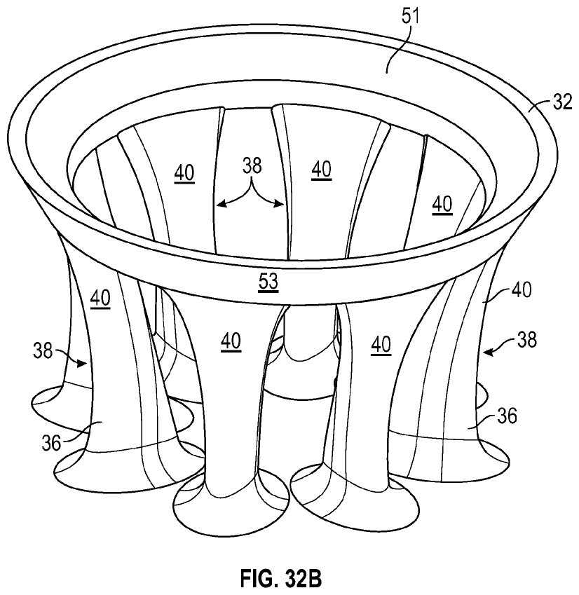

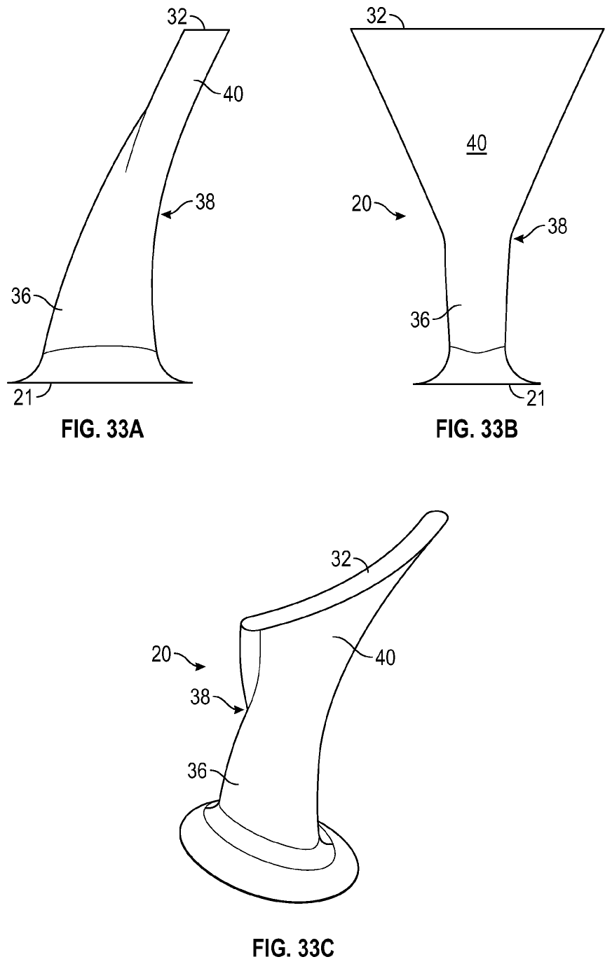

The cross-sectional profile of the through-hole Design 0804 (see FIGS. 33A-33C) is like that of Design 0802, except the downstream end of the fluid shearing section 40 (i.e., here, the through-hole outlet opening 32) is narrower and longer, while retaining the same open area as in Design 0802. Design 0804 also retains the same fluid path length (600 μm) and location of the transition region 38 (300 μm). Using similar relative locations as the previous nozzle through-hole array designs without rotation, an array of eight (8) Design 0804 nozzle through-hole microstructures 20 (see FIGS. 33A-33C) can be formed. Rather than forming individual outlet openings 32, however, the through-hole microstructures 20 of the FIG. 33 embodiment can be positioned close enough together (see FIG. 34) to form a single annular outlet channel 32 in the resulting nozzle. Such an annular outlet channel 32 can form a more continuous hollow cone-shaped plume 22. Alternatively, as shown in FIG. 32B, such a hollow cone-shaped plume 22 could also be formed, even when the individual through-hole microstructures 20 are spaced apart, by connecting together the outlet openings 32 of each through-hole microstructure 20 using a mixing chamber defined by an interior wall 51 and an exterior wall 53 that are spaced apart. Preferably, each of the walls 51 and 53 is annularly shaped, so as to form an annularly-shaped mixing chamber. It can be desirable for one or both of the walls 51 and 53 to be sloped so as to match the slope of the side of the shearing section 40 they are lined up with or otherwise correspond to. It can also be desirable for the single outlet opening 32 to have a thickness (i.e., the distance or gap between the walls 51 and 53) less than, equal to or greater than that of the individual outlet openings 32. Such a mixing chamber is expected to allow the fluid streams exiting each through-hole 20 to be sufficiently mixed together so as to form an even more continuous hollow cone-shaped plume 22. In these ways, a single outlet channel 32 can be formed, even when each of the individual through-hole microstructures has a separate outlet opening features. It may be desirable to use a single outlet channel connecting together the outlet openings of two or more, as well as all, of the through-holes 20 in the array. While such an annular shaped single outlet opening 32 may facilitate the forming of a more continuous hollow cone-shaped fluid plume 22, such a plume 22 may collapse upon itself, if the gas (e.g., air) pressure at the center of the cone-shape drops too low. Such a disadvantageous pressure drop may occur if the cone-shaped wall of the fluid plume 22 does not allow sufficient egress of the surrounding gasses (e.g., air) into the center of the plume 22.

In another embodiment of this type of the transition scheme (see FIGS. 36A-B, 38A-B), the initial section 36 is kept at a constant cross-sectional area along most or all of its length and then, at the transition region 38, the cross-sectional area either diverges (see Design 0611 of FIGS. 36A-B) or converges (see Design 0612 of FIGS. 38A-B). No inlet fillet is shown in these embodiments, but one may be included. The inlet section 36 of Design 0611 has a smaller cross-sectional area that is roughly 30% of the outlet opening cross-sectional area. In Design 0612, the inlet opening area is roughly 30% greater area than the outlet opening area, which it is believed will create a greater penetration depth then that produced with the Design 0611 for roughly the same sized through-holes 20. It is also believed that the flow rate of the Design 0612 through-hole 20 will be slightly greater than that of the Design 0611 through-hole 20 for similarly sized through-holes.

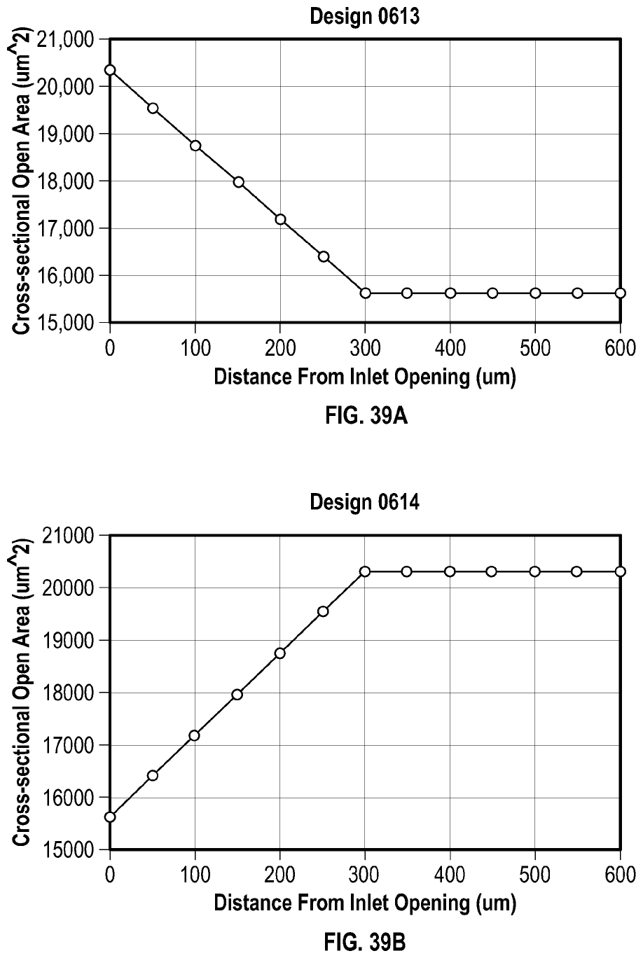

It is possible to design and manufacture through-holes where the initial section 36 either converges (Design 0613) or diverges (Design 0614) to the transition region 38 and the fluid shearing section 40 maintains a constant cross-sectional area along its central axis of flow or length (see the graphs of FIGS. 39A and 39B, respectively). One way to design such through-holes is for the major cross-sectional dimension and the minor cross-sectional dimension in the fluid shearing section to both change along the length of the fluid shearing section. In one such embodiment, the major dimension could start out being slightly longer than the minor dimension, at the upstream end of the fluid shearing section. Moving toward the upstream end of the fluid shearing section, the major dimension could begin getting longer and the minor dimension could begin getting shorter such that, at the upstream end of the fluid shearing section (e.g., in one embodiment, the outlet opening of the through-hole), the major dimension is significantly longer than the minor dimension.

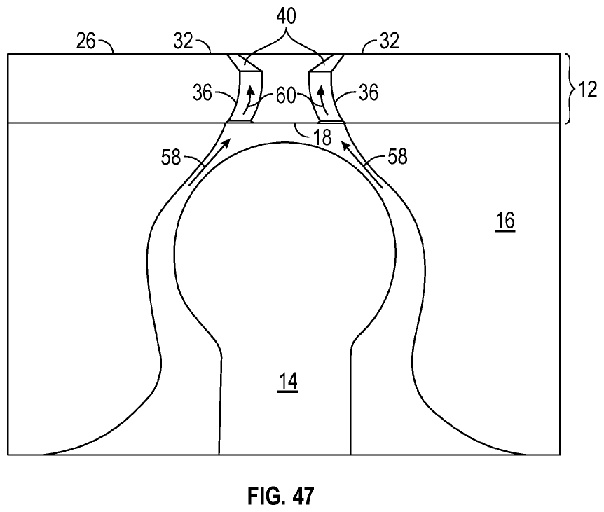

The side view of the Design 0611 and Design 0612 through-holes (see FIGS. 36A-B and 38A-B) illustrate the concept of shaping at least the initial section 36 of the through-hole 20, and even the entire through-hole cavity, to help maintain the momentum of the fluid as the fluid exits the valve aperture, rounds the ball valve, and begins entering the through-holes 20 (see, e.g., FIG. 47). In this way, the level of momentum of the fluid can be maximized or at least increased, as the fluid flows through and exits the through-hole 20. In one embodiment of a nozzle structure 12 that accomplishes this conservation of fluid momentum, the initial section 36 of the through-hole 20 has not only been curved but it has also been oriented to align with the primary path 58 (see the arrows in FIG. 47) of the fluid flowing through the valve insert 16, such that the path 60 of the fluid through the initial section 36 is in line with, or at least parallel to the fluid path 58. In an alternative way to conserve the fluid momentum, the initial section 36 can be straight but angled, as in FIG. 10A, so as to align with the primary path 58 of the fluid flowing through the valve insert 16.

Referring to FIGS. 2, 26, 45 and 46, in general, one or more in any combination or all of the through-holes 20 can include a counterbore 28 formed in the outlet face or surface 26 of the nozzle structure 12 (e.g., a nozzle plate) such that the sidewall 30 of each through-hole 20 terminates below the outlet face or surface 26. As a result, such through-holes 20 can be described as having an outlet opening 32 that is inset from the outlet face or surface 26 of nozzle plate or other nozzle structure 12, with the outlet opening 32 coinciding with a bottom surface 29 of the counterbore 28. The bottom surface 29 extends out (e.g., radially) from a central axis 31 of the counterbore 28 a desired distance wider than the through-hole outlet opening 32. The counterbore central axis 31 can be in line with, spaced apart from and parallel to, off axis and spaced apart from, or off axis and intersecting, the central axis of flow of the through-hole outlet opening 32. In some embodiments, the bottom surface 29 of the counterbore 28 extends out to and ends at a bottom peripheral edge 37 that forms the base of an outer wall 34 forming the outer periphery of the counterbore 28. At the downstream end of the counterbore 28, the outer wall 34 defines an outer peripheral edge on the nozzle outlet face or surface 26. It can be desirable for the bottom surface 29 of the counterbore 28 to define a right (90°) angle with the interior side wall 30 of the through-hole 20 at the outlet opening 32.

The addition of a counterbore 28 to a through-hole 20 of a nozzle structure 12 as described herein may, in one or more embodiments, provide additional control over the length of the through-hole 20 within the nozzle structure 12. In particular, the bottom surface 29 of the counterbore 28 may be located at any desired intermediate position within the nozzle structure 12 between the inlet face or surface 18 and the outlet face or surface 26, wherever the corresponding through-hole 20 is located. In this way, the length of the through-hole 20 (i.e., the distance between the inlet and outlet openings of the through-hole) can be made shorter than the thickness of the nozzle structure 12, by adjusting the height of the counterbore to make up the difference between the length of the through-hole 20 and the nozzle structure thickness.

A nozzle structure 12 with such a combination through-hole 20 and counterbore 28 can be made using one or more net-shape additive manufacturing processes, such as those described herein (e.g., using microstructures made by single photon or multiphoton processes). Alternatively, such a nozzle structure 12 can be constructed using electroplating (i.e., otherwise referred to as electroforming) or other additive manufacturing techniques followed by a post-forming grinding, electric discharge machining (EDM), or other material removal processing that result in some variations in the thickness of the nozzle structure between its inlet face or surface and outlet face or surface. Those post forming grinding or other material removal processes, however, do not have to affect the location of the counterbore bottom surface 29 or the location of the through-hole outlet opening 32, because those features are inset from the outlet face or surface 26 of the nozzle structure 12. In this way, the use of a counterbore 28 can allow the length of the through-hole 20 to be chosen, as desired, without concern for the distance between the inlet face or surface 18 and outlet face or surface 26 of the nozzle structure 12 being greater than the length of the through-hole 20. In other words, the use of counterbores 28 can allow the length of the through-hole 20 to be reduced without having to reduce the thickness of the nozzle structure 12.

In one or more embodiments, the counterbores 28 may be sized such that fluid exiting the outlet opening 32 of a through-hole 20 does not contact any, most or a significant portion of the bottom surface 29 and outer side wall surface 34 of the counterbore 28. The surfaces 29 and 34 of the counterbore 28 are considered to be significantly contacted by the fluid exiting the through-hole outlet opening 32, when the physical characteristics of the fluid stream exiting the through-hole 20 are significantly affected (e.g., when the desired shape and breakup of the fluid stream is not attained) or when enough fluid remains on the surfaces 29 or 34 of the counterbore 28, after an injection cycle, to result in a coking problem on the counterbore surfaces.

It can be desirable for the through-hole to have a relatively shallow depth (i.e., short length) in order to reduce the distance a fluid needs to travel, before exiting the through-hole (i.e., to reduce the amount of time a fluid remains in the through-hole). Reducing the distance the fluid must travel within the through-hole can minimize the amount of kinetic energy lost by the fluid between entering and leaving the through-hole. Maximizing or opimizing the kinetic energy retained by the fluid can help ensure that the fluid exiting the through-hole will have enough kinetic energy to travel the desired distance out of the through-hole and separate from the nozzle. It can be particularly important, when the nozzle is a fuel injector nozzle, to ensure that after the fuel injector supply valve has closed, the trailing amount of fuel remaining in the nozzle structure on the other side of the closed valve (e.g., in the through-holes of the nozzle plate or other nozzle structure) has enough kinetic energy to exit the through-hole and separate from the nozzle in time to burn in the combustion chamber (i.e., to participate in the combustion event). Any remaining fuel that does not so separate from (i.e., is still in contact with) the nozzle will likely contribute to the formation of coking deposits and, potentially, build up to the point of impeding the flow of fuel through the nozzle through-holes.

In one or more embodiments, for example, it may be desirable for the height of the counterbore 28, as measured along its central axis 31, to be less than or equal to the length of the corresponding through-hole 20, as measured from its inlet opening 21 to its outlet opening 32 at the bottom of the counterbore 28. In one or more alternative embodiments, the height of the counterbore 28 along its central axis 31 may be less than or equal to one half the length of the corresponding through-hole 20. In still other alternative embodiments, the height of the counterbore 28 along its central axis 31 may be in the range of from two times up to three times or more the length of the through-hole 20. It may also be desirable for the length or height of the through-hole to be in the range of from greater than the major dimension or width of the through-hole outlet opening 32 up to and including about three times the major dimension or width of the through-hole outlet opening 32.

In an additional variation of the counterbores 28 described above, the through-holes 20 can each include a counterbore 28 having an outer wall 34 that is formed with the same or a similar shape as the outlet opening 32 of its corresponding through-hole 20. It is believed that by matching, or coming close to, the shape of the nozzle through-hole outlet opening 32, the corresponding counterbore outer wall 34 can help control expansion of the fluid exiting the corresponding through-hole 20 and, thereby, help to generally maintain the outer shape of the exiting fluid stream. In addition, the slope of the outer wall 34 can be made to match or otherwise come close enough to the slope of the wall of the shearing section(s) 40 to help (a) avoid contact between the fluid stream exiting the outlet opening 32 and the inside surface of the counterbore wall 34, (b) control expansion of the fluid exiting the corresponding through-hole 20 and help to generally maintain the outer shape of the exiting fluid stream, or (c) both (a) and (b). An example of such a sloping counterbore 28 can be found in FIGS. 26, 45 and 46.

The major axis of the outlet opening 32 can be oriented so as to intersect with the central axis of any one or two of, or each, section 36, 38 and 40 of the through-hole 20 or none of sections 36, 38 and 40. For example, the major axis of the outlet openings 32 shown in FIGS. 18 and 41 intersect with the central axes of each section 36, 38 and 40, and the major axis of the outlet openings 32 shown in FIGS. 7-14 do not intersect with the central axis of the corresponding initial section 36, but they do intersect with the central axis of the corresponding shearing section 40. The major axis of the outlet opening 32 may also be oriented so as to intersect and form any desired angle with the central axis of any one or two of, or each, section 36, 38 and 40.

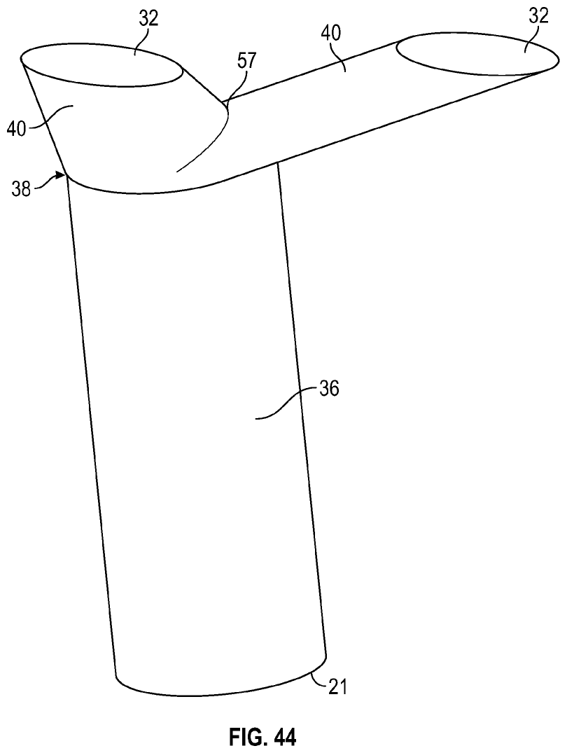

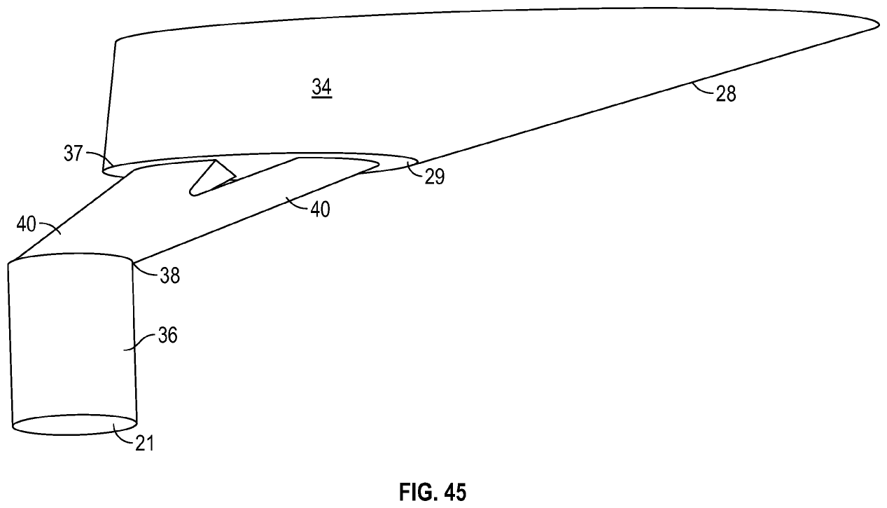

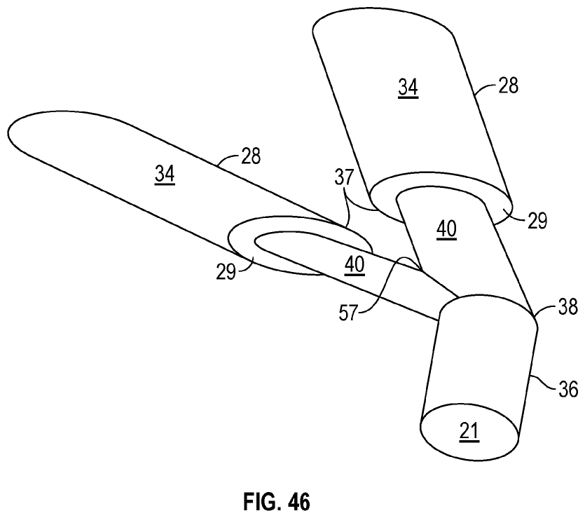

It can be desirable for the through-hole 20 to have two or more outlet openings 32. Such a nozzle configuration can be obtained, e.g., by designing one or more wedge-shaped barriers into the shearing section 40 of the nozzle through-hole 20 that separates the outlet opening 32 into two (see, e.g., FIGS. 40, 42 and 45), three (see, e.g., FIG. 43), or more outlet openings 32. This nozzle structure can be obtained by removing a corresponding wedge-shaped portion from the shearing section 40 of the through-hole microstructure 20. Each wedge-shaped portion is defined by two surfaces 55 that are separated at their outlet opening edge and joined along their opposite edge 57. Alternatively, two or more outlet openings 32 can be formed for the same through-hole 20 by forming two or more shearing sections 40 (see, e.g., FIGS. 44 and 46), where adjacent shearing sections 40 are joined along an edge or seam 57. It can be desirable for the edge 57 to be a knife edge or an otherwise sharp edge (compare the edges 57 in FIG. 43), or at least narrower rather than broader, in order to more easily divide the fluid flowing through the shearing section(s) into the outlet openings 32, while minimizing the back pressure resulting from a larger surface area (i.e., of a broader edge 57) upon which the flowing fluid can impact. As with the other through-hole configurations disclosed herein, the multiple outlet opening through-hole embodiments can include one or more counterbores 28. For example, a single counterbore 28 can be used with multiple outlet openings 32 (see, e.g., FIG. 45) or each outlet opening 32 can be formed with its own counterbore 28 (see, e.g., FIG. 46).

The nozzle structures described herein can be a flat plate, curved plate, compound curved plate, or otherwise have a three-dimensional structure where the surface of the inlet face and the surface of the outlet face are different. It can be desirable for the outlet face of the nozzle structure to be flat, hemispherical, curved or otherwise have a three-dimensional shape. It can also be desirable for all, most (i.e., greater than 50%, 55%, 60%, 65%, 70%, 75%, 80%, 85%, 90%, or 95%) or substantially none (i.e., in the range of from 0% to less than 50%, 45%, 40%, 35%, 30%, 25%, 20%, 15%, 10%, or 5%) of the surface area of the inlet face and outlet face of the nozzle structure to be exactly (i.e., within conventional fabrication tolerances) or generally (i.e., within up to about 1 degree from) parallel to each other.

Various illustrative embodiments of nozzle plates having flat inlet and outlet faces or surfaces are described and depicted above. FIGS. 1 and 2 depict cross-sectional views of one alternative illustrative embodiment of a nozzle plate having inlet and outlet faces or surfaces that have a three-dimensional shape. In particular, nozzle plate 12 includes an inlet face or surface 18 and an outlet face or surface 26. As seen in FIGS. 1 and 2, a portion of the inlet face or surface and a portion of the outlet face or surface have a three-dimensional curvature. Although the depicted three-dimensional curvature of the inlet face or surface 18 and the outlet face or surface 26 match, other alternative embodiments may include inlet and/or outlet faces or surfaces with three-dimensional curvature that do not match each other.

### Additional Embodiments

1. A fluid (e.g., a liquid or gaseous fuel) supplying nozzle (e.g., a fuel injector nozzle) comprising a nozzle structure having an inlet face or surface on an inlet side, an outlet face or surface on an outlet side, a thickness between the inlet face or surface and the outlet face or surface, and at least one or a plurality of through-holes, with each through-hole having an inlet opening on the inlet face or surface, an outlet opening on the outlet face or surface, and a cavity defined by an interior sidewall or surface located within the thickness that provides fluid communication between the inlet opening and the outlet opening, with the cavity comprising, consisting essentially of, or consisting of:

an optional initial section in fluid communication at an upstream end with the inlet opening of the through-hole (e.g., in one embodiment, the inlet opening of the through-hole defines an inlet opening to the initial section), a fluid shearing section in fluid communication at a downstream end with the outlet opening of the through-hole (i.e., in one embodiment, the outlet opening of the through-hole defines an outlet opening of the fluid shearing section), and an optional transition region disposed therebetween so as to be in fluid communication with a downstream end of the initial section and an upstream end of the fluid shearing section (i.e., fluid flowing into the initial section transitions through the transition region to the fluid shearing section),

wherein the initial section of the cavity has a length and either (a) a relatively uniform or otherwise constant cross sectional shape (e.g., circular shape, oval shape, rod shape, rectangular shape, elliptical shape, star shaped, etc.) along at least a 20%, 25% 30%, 35%, 40%, 45%, 50%, 55%, 60%, 65%, 70%, 75%, 80%, 85%, 90% or 95% portion or all of its length, and preferably the downstream portion of its length (e.g., along at least the last 50% of its length), so as to reduce turbulence and increase uniformity of the fluid reaching the transition region, (b) a converging (e.g., conical) shape that converges from the inlet opening of the through-hole to the transition region (e.g., in one embodiment, the cross-sectional area of the initial section at its upstream end is larger than the cross-sectional area of the initial section at its downstream end) so as to reduce turbulence, increase uniformity and increase the velocity or flow rate of the fluid as it passes through the converging (e.g., conical) shaped initial section and reaches the transition region, or (c) both (a) and (b),

the transition region is disposed at a single point along the length of the through-hole (e.g., any point along the through-hole where that point is located within the range of from after the first tenth to before the last tenth, after the first fifth to before the last fifth, after the first quarter to before the last quarter, after the first third to before the last third, or midway plus or minus 15%, along the through-hole length) with one cross-sectional area, or the transition region spans a sub-length that is up to about 1%, 1.5%, 2%, 2.5%, 3%, 3.5%, 4%, 4.5%, 5%, 5.5%, 6%, 6.5%, 7%, 7.5%, 8%, 8.5%, 9%, 9.5%, 10%, 10.5%, 11%, 11.5%, 12%, 12.5%, 13%, 13.5%, 14%, 14.5%, 15%, 15.5%, 16%, 16.5%, 17%, 17.5%, 18%, 18.5%, 19%, 19.5%, 20% or maybe even more of the overall through-hole length or otherwise overlaps the through-hole length, with a cross-sectional area along the length of the transition region being either relatively uniform, diverging, converging, diverging and converging, or converging and diverging from its upstream end to its downstream end (e.g., in one embodiment, the transition region is barrel shaped with a cross-section that diverges away from its upstream end and then converges towards its downstream end.), and

the fluid shearing section of the cavity has a length between an upstream end and a downstream end, with the upstream end being directly or indirectly connected or otherwise in fluid communication with a downstream end of the transition region, a diverging cross sectional shape (e.g., a flattened conical shape, fan blade shape, etc.) along at least a 20%, 25% 30%, 35%, 40%, 45%, 50%, 55%, 60%, 65%, 70%, 75%, 80%, 85%, 90% or 95% portion or all of its length, and preferably the downstream portion of its length (e.g., along at least the last 50% of its length), the diverging cross-sectional shape having a minor axis with a length and a major axis with a length, and the major axis length increases (i.e., the fluid shearing section diverges in its major axis direction along its length) toward the downstream end of the fluid shearing section, and optionally the minor axis length decreases (i.e., the fluid shearing section converges in its minor axis direction along its length) toward the downstream end of the fluid shearing section,

wherein either (i) the ratio of the major axis length to the minor axis length of the diverging cross-sectional shape of the fluid shearing section is at least 2:1 or greater (e.g., at least 2.5:1, 3:1, 3.5:1, 4:1, 4.5:1, 5:1, 5.5:1, 6:1, 6.5:1, 7:1, 7.5:1, 8:1, 8.5:1, 9:1, 9.5:1, 10:1, 10.5:1, 11:1, 11.5:1, 12:1, 12.5:1, 13:1, 13.5:1, 14:1, 14.5:1, 15:1, or even higher), (ii) the cross-sectional area at the downstream end of the fluid shearing section (or, e.g., in one embodiment, the outlet opening of the through-hole) is equal to or less than the cross-sectional area at the upstream end of the fluid shearing section (or, e.g., in one embodiment, at the downstream end of the transition region), (iii) the cross-sectional area of the downstream end of the fluid shearing section (or, e.g., in one embodiment, the outlet opening of the through-hole) is equal to or less than the cross-sectional area at the upstream end of the initial section (e.g., in one embodiment, at the inlet opening of the through-hole), (iv) the major axis length increases toward the downstream end of the fluid shearing section and the minor axis length decreases toward the downstream end of the fluid shearing section, or (v) any combination of (i), (ii), (iii) and (iv).

1a. A fluid (e.g., a liquid or gaseous fuel) supplying nozzle (e.g., a fuel injector nozzle) comprising a nozzle structure having an inlet face or surface on an inlet side, an outlet face or surface on an outlet side, a thickness between the inlet face or surface and the outlet face or surface, and at least one or a plurality of through-holes, with each through-hole having an inlet opening on the inlet face or surface, an outlet opening on the outlet face or surface, and a cavity defined by an interior sidewall or surface located within the thickness that provides fluid communication between the inlet opening and the outlet opening, with the cavity comprising, consisting essentially of, or consisting of:

a fluid shearing section in fluid communication at a downstream end with the outlet opening of the through-hole (i.e., in one embodiment, the outlet opening of the through-hole defines an outlet opening of the fluid shearing section) and in fluid communication at an upstream end with the inlet opening of the through-hole (e.g., in one embodiment, the inlet opening of the through-hole defines an inlet opening to the fluid shearing section), and an optional transition region disposed so as to be in fluid communication with an upstream end of the fluid shearing section (i.e., fluid flowing into the inlet opening of the through-hole transitions through the transition region to the fluid shearing section),

wherein the fluid shearing section of the cavity has a length between an upstream end and a downstream end, with the upstream end being directly or indirectly connected or otherwise in fluid communication with a downstream end of the transition region, a diverging cross sectional shape (e.g., a flattened conical shape, fan blade shape, etc.) along at least a 20%, 25% 30%, 35%, 40%, 45%, 50%, 55%, 60%, 65%, 70%, 75%, 80%, 85%, 90% or 95% portion or all of its length, and preferably the downstream portion of its length (e.g., along at least the last 50% of its length), the diverging cross-sectional shape having a minor axis with a length and a major axis with a length, and the major axis length increases (i.e., the fluid shearing section diverges in its major axis direction along its length) toward the downstream end of the fluid shearing section, and optionally the minor axis length decreases (i.e., the fluid shearing section converges in its minor axis direction along its length) toward the downstream end of the fluid shearing section, and

wherein the transition region is disposed at a single point (e.g., the through-hole inlet opening) along the length of the through-hole (e.g., any point along the through-hole where that point is located within the range of from the through-hole inlet opening to before the last tenth, after the first fifth to before the last fifth, after the first quarter to before the last quarter, after the first third to before the last third, or midway plus or minus 15%, along the through-hole length) with one cross-sectional area, or the transition region spans a sub-length that is up to about 1%, 1.5%, 2%, 2.5%, 3%, 3.5%, 4%, 4.5%, 5%, 5.5%, 6%, 6.5%, 7%, 7.5%, 8%, 8.5%, 9%, 9.5%, 10%, 10.5%, 11%, 11.5%, 12%, 12.5%, 13%, 13.5%, 14%, 14.5%, 15%, 15.5%, 16%, 16.5%, 17%, 17.5%, 18%, 18.5%, 19%, 19.5%, 20% or maybe even more of the overall through-hole length or otherwise overlaps the through-hole length, with a cross-sectional area along the length of the transition region being either relatively uniform, diverging, converging, diverging and converging, or converging and diverging from its upstream end to its downstream end (e.g., in one embodiment, the transition region is barrel shaped with a cross-section that diverges away from its upstream end and then converges towards its downstream end.).

1b. The nozzle according to embodiment la, wherein either (i) the ratio of the major axis length to the minor axis length of the diverging cross-sectional shape of the fluid shearing section is at least 2:1 or greater (e.g., at least 2.5:1, 3:1, 3.5:1, 4:1, 4.5:1, 5:1, 5.5:1, 6:1, 6.5:1, 7:1, 7.5:1, 8:1, 8.5:1, 9:1, 9.5:1, 10:1, 10.5:1, 11:1, 11.5:1, 12:1, 12.5:1, 13:1, 13.5:1, 14:1, 14.5:1, 15:1, or even higher), (ii) the cross-sectional area at the downstream end of the fluid shearing section (or, e.g., in one embodiment, the outlet opening of the through-hole) is equal to or less than the cross-sectional area at the upstream end of the fluid shearing section (or, e.g., in one embodiment, at the downstream end of the transition region), (iii) the cross-sectional area of the downstream end of the fluid shearing section (or, e.g., in one embodiment, the outlet opening of the through-hole) is equal to or less than the cross-sectional area at the upstream end of the inlet opening of the through-hole, (iv) the major axis length increases toward the downstream end of the fluid shearing section and the minor axis length decreases toward the downstream end of the fluid shearing section, or (v) any combination of (i), (ii), (iii) and (iv).

2. The nozzle according to embodiment 1 or 1a, wherein the upstream end of the initial section (e.g., in one embodiment, the inlet opening of the through-hole) has a cross-sectional shape with a minor axis length and a major axis length (e.g., an oval shape, rod shape, rectangular shape, elliptical shape, star shaped, etc.).

3. The nozzle according to embodiment 2, wherein the ratio of the major axis length to the minor axis length of the upstream end of the initial section (e.g., in one embodiment, the inlet opening of the through-hole) is at least 2:1 or greater (e.g., at least 2.5:1, 3:1, 3.5:1, 4:1, 4.5:1, 5:1, 5.5:1, 6:1, 6.5:1, 7:1, 7.5:1, 8:1, 8.5:1, 9:1, 9.5:1, 10:1, or even higher).

4. The nozzle according to embodiment 1 or 1a, wherein the upstream end of the initial section (e.g., in one embodiment, the inlet opening of the through-hole) has a circular cross-sectional shape.

5. The nozzle according to any one of embodiments 1, 1a and 1b to 4, wherein the downstream end of the initial section has a cross-sectional shape with a minor axis length and a major axis length (e.g., an oval shape, rod shape, rectangular shape, elliptical shape, star shaped, etc.).

6. The nozzle according to embodiment 5, wherein the ratio of the major axis length to the minor axis length of the downstream end of the initial section is at least 2:1 or greater (e.g., at least 2.5:1, 3:1, 3.5:1, 4:1, 4.5:1, 5:1, 5.5:1, 6:1, 6.5:1, 7:1, 7.5:1, 8:1, 8.5:1, 9:1, 9.5:1, 10:1, or even higher).

7. The nozzle according to embodiment 5 or 6, wherein the cross-sectional shape at the downstream end of the initial section is crescent-shaped and includes a concave (e.g., circular) side opposite a convex (e.g., circular) side along its major axis length (see, e.g., FIGS. 24, 26, 27, 31 and 33).

8. The nozzle according to embodiment 7, wherein each of the concave side and convex side, along the major axis length of the cross-sectional shape at the downstream end of the initial section, has a radius of curvature in the range of from about 100 μm up to and including about 2000 μm. The radius of curvature of the concave side and convex side can be the same or different, the concave and convex sides can be parallel or non-parallel to each other, or all possible combinations thereof.

9. The nozzle according to embodiment 5 or 6, wherein the cross-sectional shape at the downstream end of the initial section includes opposite convex (e.g., circular, eliptical) sides along its minor axis length at either end of its major axis length (see, e.g., FIG. 29).

10. The nozzle according to embodiment 9, wherein each of the convex sides, along the minor axis length of the cross-sectional shape at the downstream end of the initial section, has a radius of curvature in the range of from about 5 μm up to and including about 210 μm. The radius of curvature of the convex sides can be the same or different, the convex sides can be symmetrical or non-symmetrical to each other, or all possible combinations thereof.

11. The nozzle according to any one of embodiments 1, 1a and 1b to 3, wherein the downstream end of the initial section (e.g., in one embodiment, the inlet opening of the through-hole) has a circular cross-sectional shape.

12. The nozzle according to any one of embodiments 1, 1a and 1b to 11, wherein the transition region (e.g., its upstream end, downstream end or both) has a circular cross-sectional shape or a cross-sectional shape with a minor axis length and a major axis length (e.g., an oval shape, rod shape, rectangular shape, elliptical shape, etc.).

13. The nozzle according to embodiment 12, wherein the cross-sectional shape of said transition region has a minor axis length and a major axis length, and the ratio of the major axis length to the minor axis length of the transition region (e.g., its upstream end, downstream end or both) is at least 2:1 or greater (e.g., at least 2.5:1, 3:1, 3.5:1, 4:1, 4.5:1, 5:1, 5.5:1, 6:1, 6.5:1, 7:1, 7.5:1, 8:1, 8.5:1, 9:1, 9.5:1, 10:1, 10.5:1, 11:1, 11.5:1, 12:1, 12.5:1, 13:1, 13.5:1, 14:1, 14.5:1, 15:1, or even higher).

14. The nozzle according to embodiment 13, wherein the cross-sectional shape at the downstream end of the transition region is crescent-shaped and includes a concave (e.g., arcuate) side opposite a convex (e.g., arcuate) side along its major axis length.

15. The nozzle according to embodiment 14, wherein each of the concave side and convex side, along the major axis length of the cross-sectional shape at the downstream end of the transition region, has a radius of curvature in the range of from about 100 μm up to and including about 2000 μm. The radius of curvature of the concave side and convex side can be the same or different, the concave and convex sides can be parallel or non-parallel to each other, or all possible combinations thereof.

16. The nozzle according to any one of embodiments 14, wherein the cross-sectional shape at the downstream end of the transition region includes opposite convex (e.g., circular) sides along its minor axis length at either end of its major axis length.

17. The nozzle according to embodiment 16, wherein each of the convex sides, along the minor axis length of the cross-sectional shape at the downstream end of the transition region, has a radius of curvature in the range of from about 5 μm up to and including about 210 μm. The radius of curvature of the convex sides can be the same or different, the convex sides can be symmetrical or non-symmetrical to each other, or all possible combinations thereof.

18. The nozzle according to any one of embodiments 13 to 17, wherein the upstream end of the transition region has a circular cross-sectional shape or a cross-sectional shape with a minor axis length and a major axis length.

19. The nozzle according to any one of embodiments 1, 1a and 1b to 18, wherein the transition region has a cross-sectional area that is smaller than, larger than, or equal to the cross-sectional area of the inlet opening of the through-hole.

20. The nozzle according to any one of embodiments 1, 1a and 1b to 18, wherein the transition region has a cross-sectional area that is larger than the cross-sectional area of the inlet opening of the through-hole.

21. The nozzle according to any one of embodiments 1, 1a and 1b to 18, wherein the transition region has a cross-sectional area that is equal to the cross-sectional area of the inlet opening of the through-hole.

22. The nozzle according to any one of embodiments 1, 1a and 1b to 21, wherein the cross-sectional area of the fluid shearing section is such that fluid flowing through the transition region fills the fluid shearing section almost completely (i.e., to at least 20%, 25% 30%, 35%, 40%, 45%, 50%, 55%, 60%, 65%, 70%, 75%, 80%, 85%, 90% or 95%) of its volume or completely, before the fluid exits the fluid shearing section, and while the fluid is under the operating pressure applied when the nozzle is being used (e.g., for fuel injectors, the operating fuel pressure is typically in the range of from 100 bar up to 350 bar, and typically about 150 bar.).

23. The nozzle according to any one of embodiments 1, 1a and 1b to 22, wherein the cross-sectional shape at the downstream end of the fluid shearing section is crescent-shaped and includes a concave (e.g., circular) side opposite a convex (e.g., circular) side along its major axis length.

24. The nozzle according to embodiment 23, wherein each of the concave side and convex side, along the major axis length of the cross-sectional shape at the downstream end of the fluid shearing section, has a radius of curvature in the range of from about 100 μm up to and including about 2000 μm. The radius of curvature of the concave side and convex side can be the same or different, the concave and convex sides can be parallel or non-parallel to each other, or all possible combinations thereof.

25. The nozzle according to any one of embodiments 1, 1a and 1b to 24, wherein the cross-sectional shape at the downstream end of the fluid shearing section includes opposite convex (e.g., circular, elliptical, etc.) sides along its minor axis length at either end of its major axis length.

26. The nozzle according to embodiment 25, wherein each of the convex sides, along the minor axis length of the cross-sectional shape at the downstream end of the fluid shearing section, has a radius of curvature in the range of from about 5 μm up to and including about 210 μm. The radius of curvature of the convex sides can be the same or different, the convex sides can be symmetrical or non-symmetrical to each other, or all possible combinations thereof.

27. The nozzle according to any one of embodiments 1, 1a and 1b to 26, wherein the upstream end of the fluid shearing section has a circular cross-sectional shape.

28. The nozzle according to any one of embodiments 1, 1a and 1b to 26, wherein the cross-sectional shape at the upstream end of the fluid shearing section includes a concave (e.g., arcuate) side opposite a convex (e.g., arcuate) side along its major axis length.

29. The nozzle according to embodiment 28, wherein each of the concave side and convex side, along the major axis length of the cross-sectional shape at the upstream end of the fluid shearing section, has a radius of curvature in the range of from about 100 μm up to and including about 2000 μm. The radius of curvature of the concave side and convex side can be the same or different, the concave and convex sides can be parallel or non-parallel to each other, or all possible combinations thereof.

30. The nozzle according to any one of embodiments 1, 1a and 1b to 26, 28 and 29, wherein the cross-sectional shape at the upstream end of the fluid shearing section includes opposite convex (e.g., circular, elliptical, etc.) sides along its minor axis length at either end of its major axis length.

31. The nozzle according to embodiment 30, wherein each of the convex sides, along the minor axis length of the cross-sectional shape at the upstream end of the fluid shearing section, has a radius of curvature in the range of from about 5 μm up to and including about 210 μm. The radius of curvature of the concave side and convex side can be the same or different, the concave and convex sides can be parallel or non-parallel to each other, or all possible combinations thereof

32. The nozzle according to any one of embodiments 1, 1a and 1b to 31, wherein the fluid shearing section has a cross-sectional area that is smaller than, larger than, or equal to the cross-sectional area of the inlet opening of the through-hole.

33. The nozzle according to any one of embodiments 1, 1a and 1b to 31, wherein the fluid shearing section has a cross-sectional area that is larger than the cross-sectional area of the inlet opening of the through-hole.

34. The nozzle according to any one of embodiments 1, 1a and 1b to 31, wherein the fluid shearing section has a cross-sectional area that is equal to the cross-sectional area of the inlet opening of the through-hole.

The following are possible structural features for the fluid shearing section. It is envisioned that these structural features could be used individually or in any combination. The cross-sectional shape of the fluid shearing section, at any point along its length, along any portion of its length, or along all of its length, can remain the same, or change. For example, the downstream end of the fluid shearing section can have a major axis length in the range of from about 50 μm up to and including about 500 μm, and the upstream end of the fluid shearing section can have a major axis length in the range of from about 20 μm up to and including about 200 μm or, in the case of its cross-sectional shape being circular, a radius in the range of from about 10 μm up to and including about 100 μm. The general cross-sectional shape of the fluid shearing section can remain the same, or change, from its upstream end to its downstream end, even while the area of the cross-section shape increases or decreases from the upstream end to the downstream end. The cross-sectional shape of the fluid shearing section, at any point along its length, along any portion of its length (e.g. along a portion that includes its downstream end) or along all of its length, can include a node having a desired shape (e.g., a circular-, elliptical-, rectangular-, oval-shape, etc.) at one or both ends of the major axis length of the cross-sectional shape. The desired shape of the node can have a major axis length (e.g., the diameter of a circular-shape) in the range of from about 5 μm up to and including about 210 μm.

35. The nozzle according to any one of embodiments 1, 1a and 1b to 34, wherein the cavity of the through-hole has a central axis of flow that passes through the centers of its corresponding inlet opening and outlet opening, and the portion of the central axis of flow located in the fluid shearing section is inclined at an acute angle from the portion of the central axis of flow located in the initial section.

35a. The nozzle according to any one of embodiments 1, 1a and 1b to 35, wherein said cavity of said through-hole has a central axis of flow that passes through the centers of its corresponding inlet opening and outlet opening, and the portion of said central axis of flow located in said initial section is inclined at an acute or obtuse angle from the inlet surface of said nozzle structure.

36. The nozzle according to embodiment 35 or 35a, wherein the central axis of flow of the through-hole has a radius of curvature between the portion of the central axis of flow located in the fluid shearing section and the portion of the central axis of flow located in the initial section (e.g., the radius of curvature can be in the range of from about 10.0 μm up to and including about 200.0 μm.

37. The nozzle according to any one of embodiments 35, 35a and 36, wherein the at least one through-hole is a plurality of the through-holes that form at least part, most (i.e., more than half) or all of a through-hole array, and the central axis of flow of two or more, most (i.e., more than half) or each of the plurality of through-holes exits its corresponding outlet opening in a direction that is different than that of any of the other through-holes.

38. The nozzle according to any one of embodiments 37, wherein the acute angle formed by the central axis of flow, between the initial section and the fluid shearing section, is different for two or more, most (i.e., more than half) or each of the through-holes than for any other through-hole.

38a. The nozzle according to embodiment 37 or 38, wherein the angle at which the portion of said central axis of flow located in said initial section is inclined, from the inlet surface of said nozzle structure, is different for two or more of said through-holes than for any other through-hole.

39. The nozzle according to any one of embodiments 1, 1a and 1b to 38, wherein the at least one through-hole comprises an interior sidewall and at least one or more cavitation features in the form of a protrusion on the interior sidewall and extending into its cavity.

40. The nozzle according to embodiment 39, wherein the cavitation feature extends from only a finite area of the interior sidewall.

41. The nozzle according to embodiment 39 or 40, wherein the cavitation feature is located adjacent the downstream end of the initial section.

42. The nozzle according to any one of embodiments 39 to 41, wherein the cavitation feature is located so as to span across or otherwise overlap the transition region.

43. The nozzle according to any one of embodiments 39 to 42, wherein the cavitation feature is located adjacent the upstream end of the fluid shearing section.

44. The nozzle according to embodiment 39 or 40, wherein the cavitation feature is located adjacent the downstream end of the initial section, across the transition region and adjacent the upstream end of the fluid shearing section.

45. The nozzle according to any one of embodiments 39 to 44, wherein the cavitation feature has an upstream end and includes a major surface that inclines at an acute angle (e.g., in the range of from about 15° up to and including about 75° and any number therebetween in one degree increments) off of the interior side wall of the through-hole, from its upstream end and toward the outlet opening of the at least one through-hole.

46. The nozzle according to embodiment 45, wherein the cavitation feature has a downstream end and includes a minor surface at its downstream end that connects the major surface to the interior sidewall of the through-hole and forms an obtuse angle with the interior side wall of the through-hole.

47. The nozzle according to any one of claims 39 to 46, wherein said at least one cavitation feature is narrower at its upstream end and broader at its downstream end.

47a. The nozzle according to any one of embodiments 39 to 46, wherein the at least one cavitation feature is a plurality of the cavitation feature.

48. The nozzle according to any one of embodiments 1, 1a and 1b to 47, wherein the at least one through-hole is a plurality of the through-holes.

49. The nozzle according to embodiment 48, wherein the plurality of through-holes are spaced apart so as to form at least part, most (i.e., more than half) or all of a through-hole array.

50. The nozzle according to embodiment 48 or 49, wherein the through-holes are at least two, three, four, five or six through-holes that are each shaped differently to produce a different fluid exit stream (e.g., a different range of droplet sizes, average droplet size, penetration distance from the nozzle outlet surface.

51. The nozzle according to any one of embodiments 48 to 50, wherein each of the through-holes is shaped differently.

52. The nozzle according to any one of embodiments 48 to 51, wherein fluid flowing out of the plurality of through-holes forms a fluid spray pattern or plume having the shape of a hollow cone.

53. The nozzle according to any one of embodiments 1, 1a and 1b to 52, wherein the nozzle structure is a monolithic single piece structure (e.g., a nozzle plate or combination nozzle plate and valve guide) defined, at least in part, by the inlet face or surface and the outlet face or surface. The nozzle structures described herein may be constructed of any material or materials suitable for being used in nozzles, e.g., one of more metals, metal alloys, ceramics, etc. In one or more embodiments, a nozzle structure as described herein can be made, e.g., from electroplatable metal (e.g., nickel or a nickel alloy), although other conventional additive metal manufacturing processes (e.g., metal particle sintering) may also be used.

54. The nozzle according to any one of embodiments 1, 1a and 1b to 53, wherein the at least one through-hole is configured so that the velocity of the fluid flowing into the at least one through-hole is lower than the velocity of the fluid flowing out of the at least one through-hole (e.g., the inlet opening of the through-hole can be made to have a larger cross-sectional area than the cross-sectional area of the through-hole outlet opening).

55. The nozzle according to any one of embodiments 1, 1a and 1b to 54, wherein the nozzle structure further comprises a counterbore between the outlet opening of the through-hole and the outlet face or surface.

56. The nozzle according to any one of embodiments 1, 1a and 1b to 55, wherein the cavity of the through-hole has a central axis of flow that causes fluid to flow out of the through-hole at an acute or obtuse angle from the outlet face or surface.

The nozzle structure can be, e.g., a one-piece nozzle plate, a combination nozzle plate and valve guide that are either formed as one unitary structure or formed separately and joined together (e.g., by welding, etc.), or any other structure that has formed therein the one or more through-holes. Such a nozzle structure can be used to supply any fluid (i.e., a liquid or gas) for a particular use in a given system and/or process. For example, the nozzle structure can be used in a fuel injector to supply a liquid or gaseous spray of fuel (e.g., gasoline, alcohol, methane, butane, propane, natural gas, etc.) into a combustion chamber of an internal combustion engine.

57. The nozzle according to any one of embodiments 1, 1a and 1b to 56, wherein the nozzle structure is a fuel injector nozzle structure.

58. The nozzle according to any one of embodiments 1, 1a and 1b to 57, wherein the nozzle structure is operatively adapted (i.e., dimensioned, configured or otherwise designed) for supplying a liquid fuel (e.g., gasoline, diesel, alcohol, fuel oil, jet fuel, urea, etc.) to a combustion chamber of an internal combustion engine.

59. The nozzle according to any one of embodiments 1, 1a and 1b to 58, wherein the nozzle structure is operatively adapted (i.e., dimensioned, configured or otherwise designed) for supplying a gaseous fuel (e.g., natural gas, propane, butane, etc.) to a combustion chamber of an internal combustion engine.

60. The nozzle according to any one of embodiments 1, 1a and 1b to 59, wherein the nozzle structure comprises a nozzle plate and a valve guide (see, e.g., FIGS. 1, 2, 3 and 47). The nozzle plate and the valve guide can be a single piece structure (see, e.g., FIGS. 1 and 2), such as when they are an integrally formed together as one part (e.g., by using an additive manufacturing process). An exemplary additive manufacturing process can include a multi-photon process and an electroplating/electroforming process. Alternatively, the nozzle plate and the valve guide can be formed separately and then joined together (see, e.g., FIGS. 3A and 47), e.g., by being welded together.

61. The nozzle according to any one of embodiments 1, 1a and 1b to 60, wherein the inlet face or surface and outlet face or surface are parallel to each other, at least around the periphery thereof (e.g., where it may be welded), within plus or minus about 0.5 or 1 degrees.

62. The nozzle according to any one of embodiments 1, 1a and 1b to 61, wherein at least one or both of the inlet and outlet faces or surfaces have a three-dimensional curvature (see, e.g., FIGS. 1 and 2).

63. A fuel injector comprising a nozzle according to any one of embodiments 1, 2 and 3 to 62.

64. A fuel system comprising the fuel injector of embodiment 63.

65. An internal combustion engine comprising the fuel system of embodiment 64.

66. The internal combustion engine of embodiment 65 being a gasoline direct injection engine.

This invention may take on various modifications and alterations without departing from its spirit and scope. The following are examples of such modifications and alterations:

Accordingly, this invention is not limited to the above-described embodiments but is to be controlled by the limitations set forth in the following claims and any equivalents thereof. In addition, this invention may be suitably practiced in the absence of any element not specifically disclosed herein.

All patents and patent applications cited above, including those in the Background section, are incorporated by reference into this document in total.

1. A nozzle comprising a nozzle structure having an inlet surface on an inlet side, an outlet surface on an outlet side, a thickness between the inlet surface and the outlet surface, and at least one through-hole having an inlet opening on the inlet surface, an outlet opening on the outlet surface, and a cavity that provides fluid communication between the inlet opening and the outlet opening, with said cavity comprising:
an initial section in fluid communication at an upstream end with the inlet opening of said through-hole, a fluid shearing section in fluid communication at a downstream end with the outlet opening of said through-hole, and a transition region disposed therebetween so as to be in fluid communication with a downstream end of said initial section and an upstream end of said fluid shearing section,
wherein said initial section of said cavity has a length and a relatively uniform or otherwise constant cross sectional shape along at least a 20% portion of its length so as to reduce turbulence and increase uniformity of the fluid reaching said transition region,
said transition region is disposed at a single point along the length of said through-hole with one cross-sectional area, and
said fluid shearing section of said cavity has a length between an upstream end and a downstream end, with the upstream end being in fluid communication with a downstream end of said transition region, a diverging cross sectional shape along at least a 20% portion of its length, said diverging cross-sectional shape having a minor axis length and a major axis length, and the major axis length increases toward the downstream end of said fluid shearing section, and optionally the minor axis length decreases toward the downstream end of said fluid shearing section,
wherein the cross-sectional area at the downstream end of the fluid shearing section is less than the cross-sectional area at the upstream end of the fluid shearing section, and
wherein said cavity of said through-hole has a central axis that passes through the centers of its corresponding inlet opening and outlet opening, and (a) the portion of said central axis located in said fluid shearing section is inclined at an acute angle from the portion of said central axis located in said initial section.

2. A fluid supplying nozzle comprising a nozzle structure having an inlet face or surface on an inlet side, an outlet face or surface on an outlet side, a thickness between the inlet face or surface and the outlet face or surface, and at least one or a plurality of through-holes, with each through-hole having an inlet opening on the inlet face or surface, an outlet opening on the outlet face or surface, and a cavity defined by an interior sidewall or surface located within the thickness that provides fluid communication between the inlet opening and the outlet opening, with the cavity comprising, consisting essentially of, or consisting of:
a fluid shearing section in fluid communication at a downstream end with the outlet opening of the through-hole and in fluid communication at an upstream end with the inlet opening of the through-hole, and an optional transition region disposed so as to be in fluid communication with an upstream end of the fluid shearing section,
wherein the fluid shearing section of the cavity has a length between an upstream end and a downstream end, with the upstream end being in fluid communication with a downstream end of the transition region, a diverging cross sectional shape along at least a portion of its length, the diverging cross-sectional shape having a minor axis with a length and a major axis with a length, and the major axis length increases toward the downstream end of the fluid shearing section, and optionally the minor axis length decreases toward the downstream end of the fluid shearing section, and
wherein the transition region is disposed at a single point along the length of the through-hole with one cross-sectional area.

3. The nozzle according to claim 2, wherein either (i) the ratio of the major axis length to the minor axis length of the diverging cross-sectional shape of the fluid shearing section is at least 2:1 or greater, (ii) the cross-sectional area at the downstream end of the fluid shearing section is equal to or less than the cross-sectional area at the upstream end of the fluid shearing section, (iii) the cross-sectional area of the downstream end of the fluid shearing section is equal to or less than the cross-sectional area at the upstream end of the inlet opening of the through-hole, (iv) the major axis length increases toward the downstream end of the fluid shearing section and the minor axis length decreases toward the downstream end of the fluid shearing section, or (v) any combination of (i), (ii), (iii) and (iv).

4. The nozzle according to claim 1, wherein (a) the upstream end of said initial section has a cross-sectional shape with a minor axis length and a major axis length, (b) the downstream end of said initial section has a cross-sectional shape with a minor axis length and a major axis length, or (c) both (a) and (b).

5. The nozzle according to claim 4, wherein the cross-sectional shape at the downstream end of said initial section includes a concave side opposite a convex side along its major axis length or opposite convex sides along its minor axis length at either end of its major axis length.

6. The nozzle according to claim 1, wherein said transition region has a circular cross-sectional shape or a cross-sectional shape with a minor axis length and a major axis length.

7. The nozzle according to claim 1, wherein the upstream end of said transition region has a circular cross-sectional shape or a cross-sectional shape with a minor axis length and a major axis length, and said transition region has a cross-sectional area that is smaller than, larger than, or equal to the cross-sectional area of the inlet opening of the through-hole.

8. The nozzle according to claim 1, wherein the cross-sectional area of said fluid shearing section is such that fluid flowing through said transition region fills said fluid shearing section to at least 20%, of its volume, before the fluid exits said fluid shearing section.

9. The nozzle according to claim 1, wherein the cross-sectional shape at the downstream end of said fluid shearing section includes (a) a concave side opposite a convex side along its major axis length, (b) opposite convex sides along its minor axis length at either end of its major axis length, or (c) both (a) and (b).

10. The nozzle according to claim 1, wherein the upstream end of said fluid shearing section has a circular cross-sectional shape, or the cross-sectional shape at the upstream end of said fluid shearing section includes a concave side opposite a convex side along its major axis length.

11. The nozzle according to claim 1, wherein the cross-sectional shape at the upstream end of said fluid shearing section includes opposite convex sides along its minor axis length at either end of its major axis length.

12. The nozzle according to claim 1, wherein said fluid shearing section has a cross-sectional area that is smaller than, larger than, or equal to the cross-sectional area of the inlet opening of said through-hole.

13. The nozzle according to claim 1, wherein the portion of said central axis located in said initial section is inclined at an angle from the inlet surface of said nozzle structure, or (c) both (a) and (b).

14. The nozzle according to claim 13, wherein said central axis of said through-hole has a radius of curvature between the portion of said central axis located in said fluid shearing section and the portion of said central axis located in said initial section.

15. The nozzle according to claim 1, wherein said at least one through-hole comprises an interior sidewall and at least one cavitation feature in the form of a protrusion on said interior sidewall and extending into its cavity.

16. The nozzle according to claim 15, wherein said cavitation feature (a) is located adjacent the downstream end of said initial section, (b) is located so as to overlap said transition region, (c) is located adjacent the upstream end of said fluid shearing section, (d) is located adjacent the downstream end of said initial section, across said transition region and adjacent the upstream end of said fluid shearing section, or any combination of (a) to (c).

17. The nozzle according to claim 1, wherein said at least one through-hole is a plurality of said through-holes, and fluid flowing out of said plurality of through-holes forms a fluid spray pattern or plume having the shape of a hollow cone.

18. The nozzle according to claim 1, wherein said nozzle structure is a fuel injector nozzle structure.
